(19) United States
(12) Patent Application Publication
(10) Pub. No.: US 2004/0093559 A1
(43) Pub. Date: May 13, 2004

(54) Web client for viewing and interrogating enterprise data semantically

(76) Inventors: Ruth Amaru, Gush Etzion (IL); Ben Berger, Modi'in (IL); Rannen Meir, Jerusalem (IL); Boris Melamed, Jerusalem (IL); Zvi Schreiber, Jerusalem (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/637,171

(22) Filed: Aug. 7, 2003

Related U.S. Application Data
(63) Continuation-in-part of application No. 10/302,370, filed on Nov. 22, 2002.
Application No. 10/302,370 is a continuation-in-part of application No. 10/159,516, filed on May 31, 2002.
Application No. 10/159,516 is a continuation-in-part of application No. 10/104,785, filed on Mar. 22, 2002.
Application No. 10/104,785 is a continuation-in-part of application No. 10/053,045, filed on Jan. 15, 2002.
Application No. 10/053,045 is a continuation-in-part of application No. 09/904,457, filed on Jul. 6, 2001.
Application No. 09/904,457 is a continuation-in-part of application No. 09/866,101, filed on May 25, 2001.

(51) Int. Cl. G06F 17/00

(52) U.S. Cl. 715/502

(57) ABSTRACT

A portal for interactively viewing enterprise metadata, including a memory for storing a data structure in the form of a graph, with nodes representing asset metadata for enterprise data assets and edges representing relationships between asset metadata, a path finder for generating at least one path within the graph satisfying prescribed constraints, and a report generator for generating a report about the graph, based on paths generated by the path finder. A method and computer readable storage medium are also described and claimed.

### CROSS REFERENCES TO RELATED APPLICATIONS

This application is a continuation-in-part of assignee's pending application U.S. Ser. No. 10/302,370, filed on Nov. 22, 2002, entitled “Enterprise Information Unification”, which is a continuation-in-part of assignee's pending application U.S. Ser. No. 10/159,516, filed on May 31, 2002, entitled “Data Query and Location through a Central Ontology Model,” which is a continuation-in-part of application U.S. Ser. No. 10/104,785, filed on Mar. 22, 2002, entitled “Run-Time Architecture for Enterprise Integration with Transformation Generation,” which is a continuation-in-part of application U.S. Ser. No. 10/053,045, filed on Jan. 15, 2002, entitled “Method and System for Deriving a Transformation by Referring Schema to a Central Model,” which is a continuation-in-part of assignee's application U.S. Ser. No. 09/904,457 filed on Jul. 6, 2001, entitled “Instance Brower for Ontology,” which is a continuation-in-part of assignee's application U.S. Ser. No. 09/866,101 filed on May 25, 2001, entitled “Method and System for Collaborative Ontology Modeling.”

### FIELD OF THE INVENTION

The present invention relates to enterprise data management, and more particularly to understanding the structure and content of enterprise data repositories, and working with them, in a comprehensive way.

### BACKGROUND OF THE INVENTION

One of the difficult challenges faced by enterprise information technology is that of managing diversity. Data sources for large enterprises can be substantially different from one another, and are often comprehensible only by special purpose application programs. Sales data, accounting data, inventory data, purchasing data, human resources data—all of these data sources inter-relate to some extent, but cross-data processing requires much manual effort and development of special purpose adaptors to bridge each pair of data sources.

Moreover diverse data sources typically use diverse data structures, including for example COBOL record systems, relational database systems, XML document systems, and in many cases custom proprietary data schema.

Making the challenge of managing diversity even more difficult, individual data sources typically have their own lexicon for business entities. For example, purchasing data may be keyed on an enterprise's SKU classification, sales data may be keyed on model numbers, and payroll data may be keyed on social security and income tax based systems. For an accounting program to determine profit based on sales revenue vs. cost of goods and cost of labor, it is necessary to bridge the three lexicons.

The older the enterprise, and the larger the enterprise, the more diversity likely exists among its data sources. How does such diversity arise? Some of it arises by legacy—electronic data processing systems have been around for well over fifty years, and as computer technology advances new systems supplant older ones. Some of it arises by growth, through mergers and acquisitions. Some of it arises by use of proprietary data processing systems, perhaps for reasons of security or customization.

There is thus a pressing need for understanding the content and structure of enterprise data repositories, and working with them.

### SUMMARY OF THE INVENTION

The present invention provides a method and system for understanding enterprise data repositories, by enabling a user to visualize and interrogate enterprise data schemas in a comprehensive way.

There is thus provided in accordance with a preferred embodiment of the present invention a portal for interactively viewing enterprise metadata, including a memory for storing a data structure in the form of a graph, with nodes representing asset metadata for enterprise data assets and edges representing relationships between asset metadata, a path finder for generating at least one path within the graph satisfying prescribed constraints, and a report generator for generating a report about the graph, based on paths generated by the path finder.

There is further provided in accordance with a preferred embodiment of the present invention a method for interactively viewing enterprise metadata, including providing a data structure in the form of a graph, with nodes representing asset metadata for enterprise data assets and edges representing relationships between asset metadata, generating at least one path within the graph satisfying prescribed constraints, and generating a report about the graph, based on paths generated by said path finder.

There is yet further provided in accordance with a preferred embodiment of the present invention a computer-readable storage medium storing program code for causing a computer to perform the steps of providing a data structure in the form of a graph, with nodes representing asset metadata for enterprise data assets and edges representing relationships between asset metadata generating at least one path within the graph satisfying prescribed constraints, and generating a report about the graph, based on paths generated by said path finder.

The following definitions are employed throughout the specification and claims.

1. Asset, also Data Asset—a storage of enterprise data, such as relational database tables and XML documents.

2. Asset Constructs, also Asset Concepts—basic data structure elements of an Asset Schema, such as fields and tables for relational database schema, and simple and complex types for an XML schema.

3. Asset Metadata, also Asset Schema—a format for data stored within an Asset, such as a relational database schema and an XML schema.

4. Atomic Construct—a simple construct within Asset Metadata, used as a building block for Composite Constructs, such as a table column, or field, within a relational database schema, or an XML simple type within an XML schema.

5. Business Rule—a constraint on data corresponding to constructs of a schema, such as an enumeration of all possible construct values, or a conversion formula relating construct values. Preferably, a business rule applies to property values for the Information Model.

6. Composite Construct—a construct within Asset Metadata built up from Atomic Construct, such as a table in a relational database schema, or an XML complex type within an XML schema

7. Information Model—a semantic model for enterprise data, such as an ontology model.

8. Mapping—a correspondence between constructs of an Asset and corresponding constructs of an Information Model.

9. Ontology Model—a data schema including classes and properties thereof, and an inheritance relation whereby properties of a class are inherited by its subclasses.

10. Package—a portion of a Project stored in a common file, similar to packages used with Java classes

11. Project—an overall archive including enterprise data assets, an Information Model, mappings of Data Assets into the Information Model, Test Instances, stored Data Transformations and stored searches.

12. Test Instances, also Instances—specific Asset data with values for constructs of an Asset Schema. Test instances may be valid or invalid, depending on whether or not they are compliant with the Asset Schema, respectively.

13. Transformation, also Data Transformation—rules for transforming data from one Asset Schema to another Asset Schema.

### BRIEF DESCRIPTION OF THE DRAWINGS

The present invention will be more fully understood and appreciated from the following detailed description, taken in conjunction with the drawings in which:

FIGS. 1A-1E are illustrations of a user interface for data management, in accordance with a preferred embodiment of the present invention;

FIGS. 2A-2K are illustrations of a user interface for data integration, in accordance with a preferred embodiment of the present invention;

FIGS. 3A-3E are illustrations of a user interface for impact analysis, in accordance with a preferred embodiment of the present invention;

FIGS. 4A-4D are illustrations of a user interface for data quality, in accordance with a preferred embodiment of the present invention;

FIGS. 5A-5C are illustrations of a user interface for search and re-use, in accordance with a preferred embodiment of the present invention;

FIG. 6 is an illustration of a user interface for a data thesaurus, in accordance with a preferred embodiment of the present invention;

FIG. 7 is an illustration of a user interface for data reports, in accordance with a preferred embodiment of the present invention;

FIG. 8 is an illustration of a user interface for data administration, in accordance with a preferred embodiment of the present invention;

FIGS. 9A-9C are illustrations of a user interface for building an information model, in accordance with a preferred embodiment of the present invention;

FIGS. 10A and 10B are illustrations of a user interface for mapping assets to an information model, in accordance with a preferred embodiment of the present invention;

FIG. 11A is an illustration of a user interface for discovering associations between asset metadata, in accordance with a preferred embodiment of the present invention;

FIG. 11B is an illustration of details of an association discovered in FIG. 11A, in accordance with a preferred embodiment of the present invention;

FIGS. 12A and 12B are illustrations of a user interface for generating transformations, in accordance with a preferred embodiment of the present invention;

FIG. 13 is an illustration of a user interface for test instances, in accordance with a preferred embodiment of the present invention;

FIG. 14 is an illustration of a user interface for obtaining general information about an enterprise information project, in accordance with a preferred embodiment of the present invention; and

FIG. 15 is a simplified block diagram for a web portal server that enables an interactive web client, in accordance with a preferred embodiment of the present invention.

### DETAILED DESCRIPTION OF A PREFERRED EMBODIMENT

The present invention provides a method and system for viewing & interrogating an enterprise repository of data asset metadata.

Enterprise data is typically distributed over multiple databases, referred to as data assets, or just assets for short. Data assets can be of various types, including inter alia relational database tables, XML databases, entity-relationship (ER) databases and Cobol databases. Each data asset stores data according to a specific data structure format, referred to as a schema, or as asset metadata. Asset metadata serves as descriptors, explaining how to interpret data stored within the asset. Without knowledge of the asset metadata, data stored within the asset is generally unintelligible. Thus, for example, relational database tables store data according to a relational database schema, XML documents store data according to an XML schema, ER databases store data according to an ER logical model, and Cobol databases store data according to a Cobol Copybook. Each such schema is in effect asset metadata, which explains how to interpret data stored within the asset.

The present invention is preferably embodied in a viewer and interrogation application, or tool, that enables a client to interactively view & interrogate metadata for an enterprise data repository. As described hereinbelow, the present invention preferably applies at the level of the asset schema, rather than at the level of the data itself within the assets. Data modeling often refers to asset data itself, such as populated tables within a relational database and populated XML documents within an XML database, as being level M0 metadata, and asset schema, such as a relational database schema or an XML schema, as being level M1 metadata. Thus the present invention is preferably used to interactively view and interrogate repository M1 metadata. Results generated by the present invention, such as transformation and validation scripts, are often used within database management systems on level M0 metadata; i.e., on enterprise data itself.

Asset metadata is generally authored by one or more people serving as data administrators, and is preferably stored within one or more packages. A package is a collection of metadata for one or more data assets, similar to the package used in Java to store one or more Java classes. Breakdown of asset metadata into packages is arbitrary, although it is customary that packages have a common theme, such as financial asset metadata, sales asset metadata or customer asset metadata. Packages themselves may be broken down into sub-packages. For example, a package for sales metadata may include sub-packages of metadata for government sales, military sales, and foreign country sales, and each sub-package may be authored by a different person.

Asset metadata is typically comprised of basic data structures, or constructs. For example, relational database schema are comprised of fields and tables, XML schema are comprised of simple types and complex types, ER logical models are comprised of entities and relationships, and Cobol Copybooks are comprised of elementary items and group items.

More generally, asset metadata often includes two types of constructs: a simple constructs, referred to as an atom, and a complex construct, referred to as a composite, which is used to organize multiple atoms. For example, atoms within a relational database schema are individual fields, or table columns, and composites are tables. Similarly, atoms within an XML schema are simple types, and composites are complex types.

In a preferred embodiment of the present invention, semantics are provided to enterprise data through (i) a global ontology model, referred to also as an information model; and (ii) mappings of enterprise asset metadata into the ontology model. An ontology model is comprised of classes, which correspond to composite constructs, and properties, which correspond to atomic constructs, and is particularly useful for representing data in a semantically meaningful way. Mappings are associations of constructs of a first asset metadata with constructs of a second asset metadata, and generally identify atoms with atoms and composites with composites in a consistent way. Mappings of asset metadata into the ontology model serve as dictionaries through which constructs of the asset metadata can be semantically understood.

Altogether, asset metadata, the information model and the mappings are part of a unified enterprise information archive referred to herein as a project.

Ontology models and mappings of asset metadata into an ontology model are described in applicant's co-pending patent applications, as follows:

U.S. Ser. No. 09/866,101, filed on May 25, 2001 and entitled “Method and System for Collaborative Ontology Modeling”;

U.S. Ser. No. 09/904,457, filed on Jul. 6, 2001 and entitled “Instance Browser for Ontology”;

U.S. Ser. No. 10/053,045, filed on Jan. 15, 2002 and entitled “Method and System for Deriving a Transformation by Referring Schema to a Central Model”;

U.S. Ser. No. 10/104,785, filed on Mar. 22, 2002 and entitled “Run-Time Architecture for Enterprise Integration with Transformation Generation”;

U.S. Ser. No. 10/159,516, filed on May 31, 2002 and entitled “Data Query and Location through a Central Ontology Model”;

U.S. Ser. No. 10/302,370, filed on Nov. 2, 2002 and entitled “Enterprise Information Unification”; and

U.S. Ser. No. 10/340,068, filed on Jan. 9, 2003 and entitled “Brokering Semantics between Web Services”.

The contents of the above U.S. patent applications are hereby incorporated by reference.

Enterprise Asset Metadata: Viewing & Interrogation

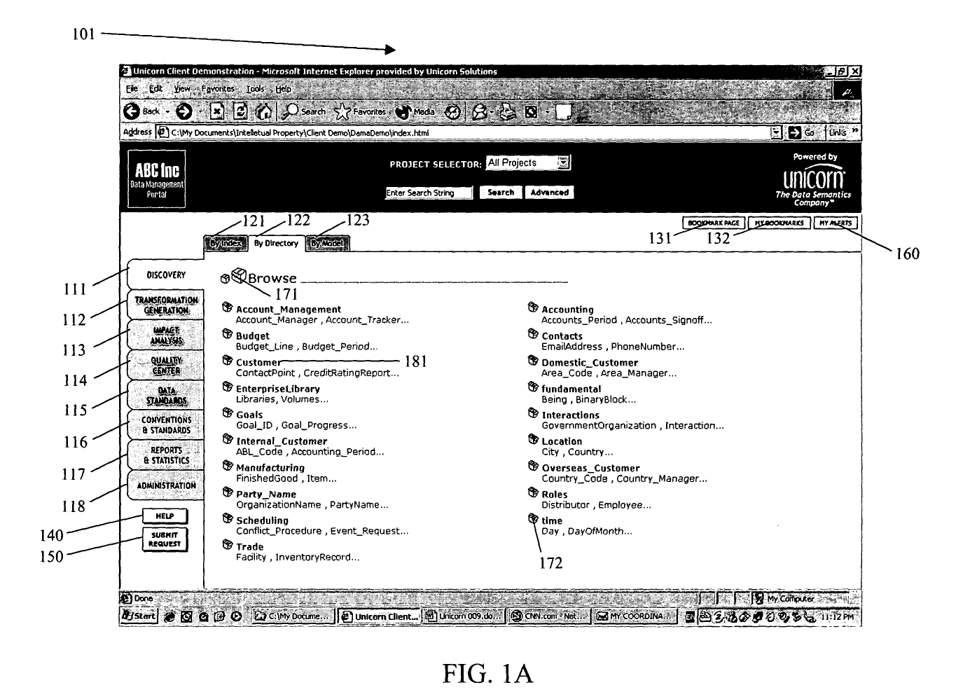

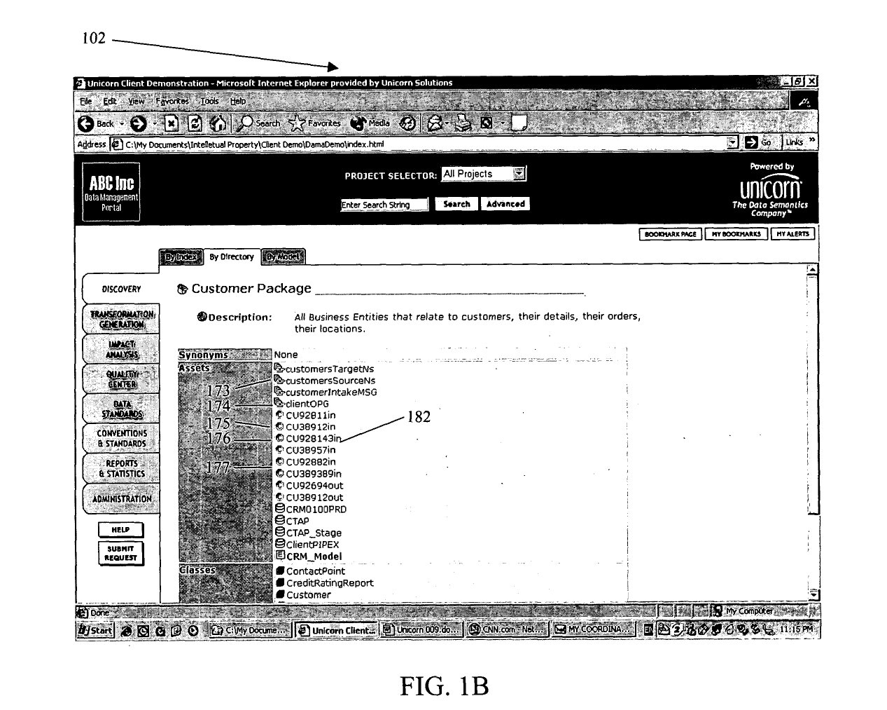

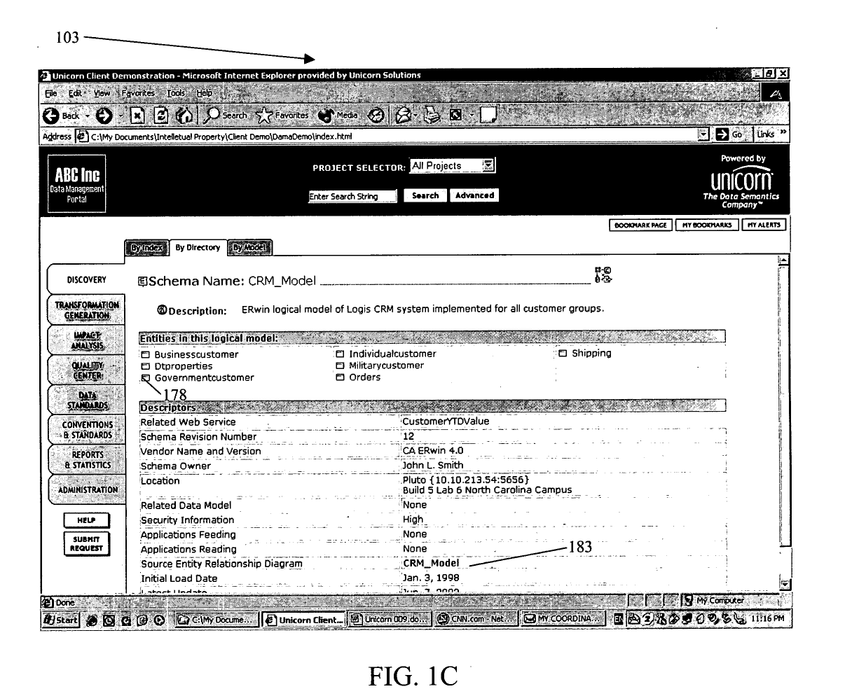

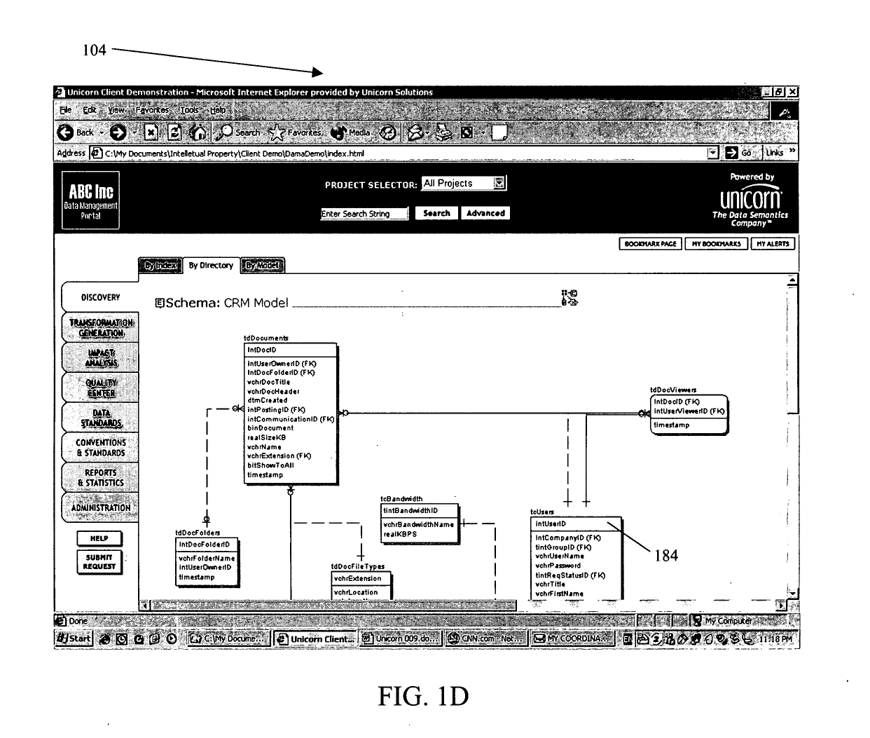

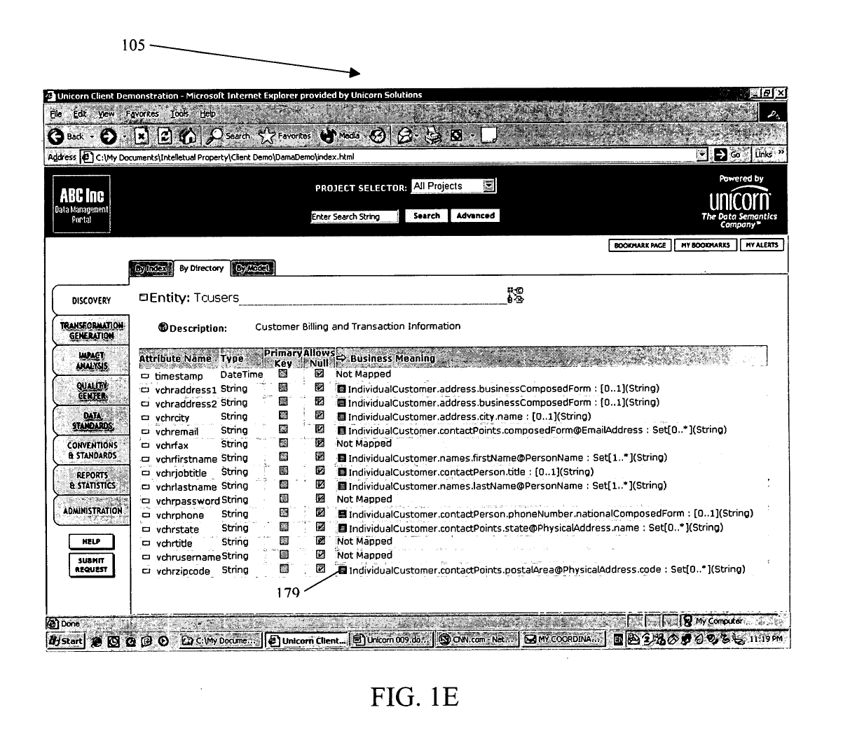

Reference is now made to FIGS. 1A-1E, which are illustrations of a user interface for data management, in accordance with a preferred embodiment of the present invention. Shown in FIG. 1A is a user interface screen 101 that is part of an overall enterprise repository asset metadata viewer & interrogation tool. In a preferred embodiment of the present invention, the viewer & interrogation application is implemented as a web client, through a web browser such as Internet Explorer, as illustrated in FIG. 1A. In this embodiment, screen 101 and other screens illustrated hereinbelow are rendered from web pages, such as HTML or XML pages. However, it may be readily appreciated by those skilled in the arts that the viewer & interrogation tool of the present invention may alternatively be implemented using different software architectures, including inter alia as a standalone application, or as an ActiveX control or as a browser plug-in.

In a preferred embodiment of the present invention, the web pages for the enterprise repository that are interactively navigated by the viewer & interrogation tool, are generated by a modeling & construction tool, used to integrate enterprise data assets, and develop the information model and mappings from the assets thereto. Preferably, the modeling & construction tool of the present invention enables a user to publish enterprise repository metadata to the web.

In an alternate embodiment of the present invention, the web pages used by the viewer & interrogation tool are dynamically generated web pages, such as active server pages or Java server pages, which are generated by servlets in response to inputs received from HTTP requests.

Preferably, the viewer & interrogation tool includes tabs 111-118 for eight workflows, as follows:

a “Discovery” tab 111, shown selected in FIG. 1A, for navigating through an enterprise data repository of company “ABC Inc”, to view asset metadata and the information model, as illustrated in FIGS. 1A-1E;

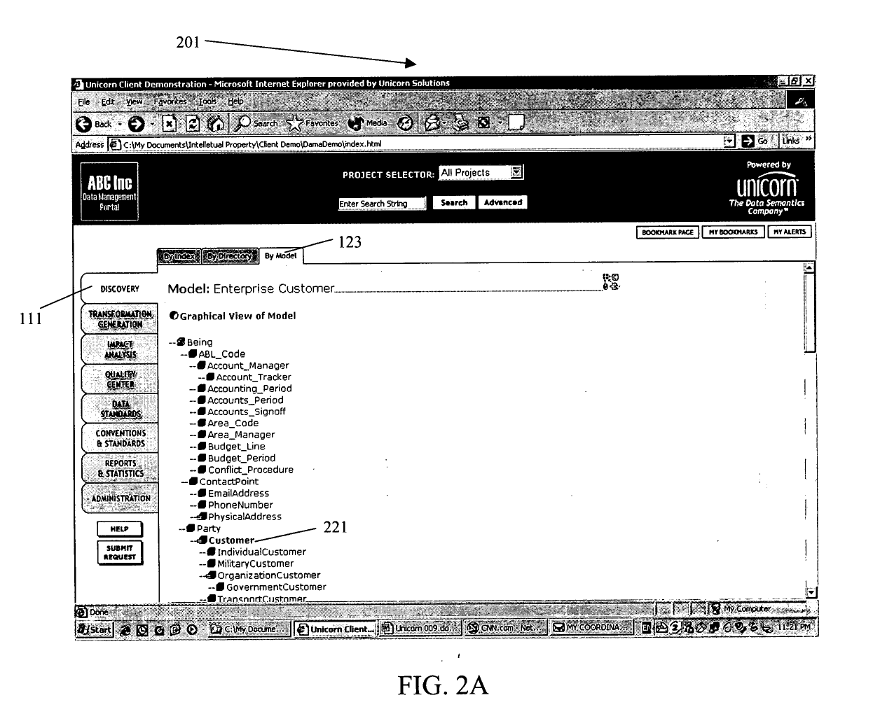

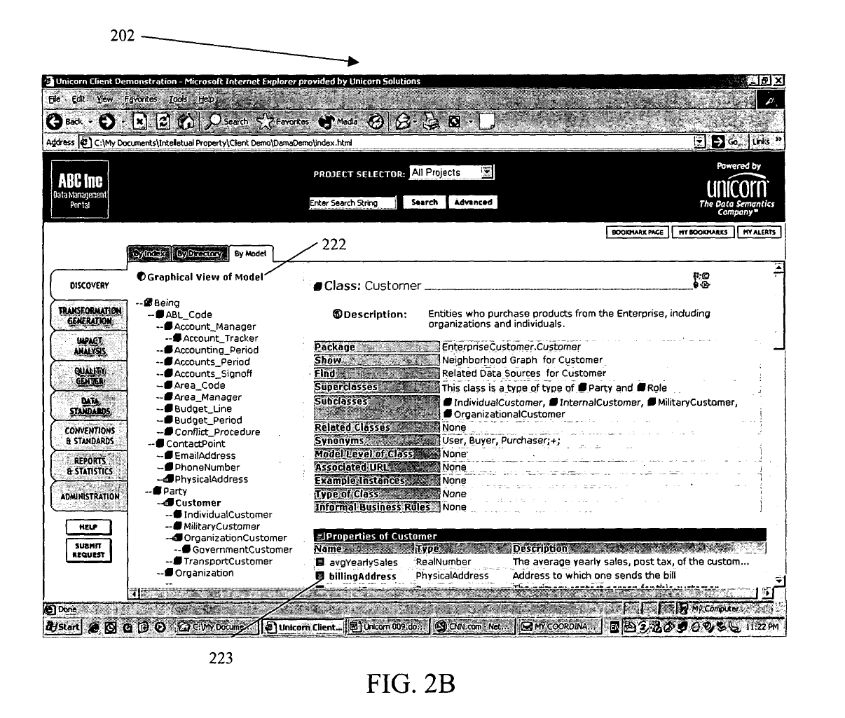

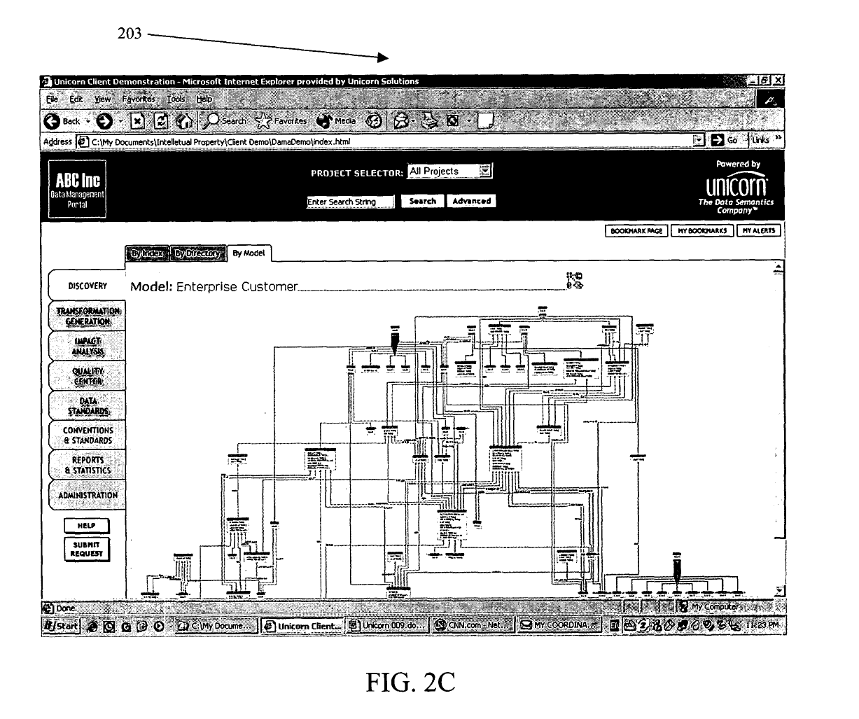

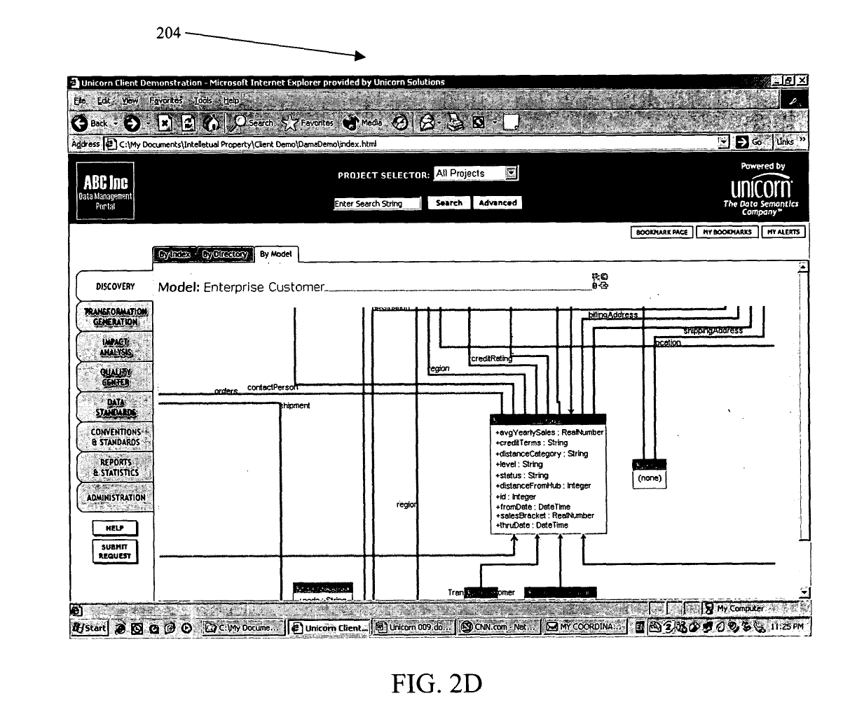

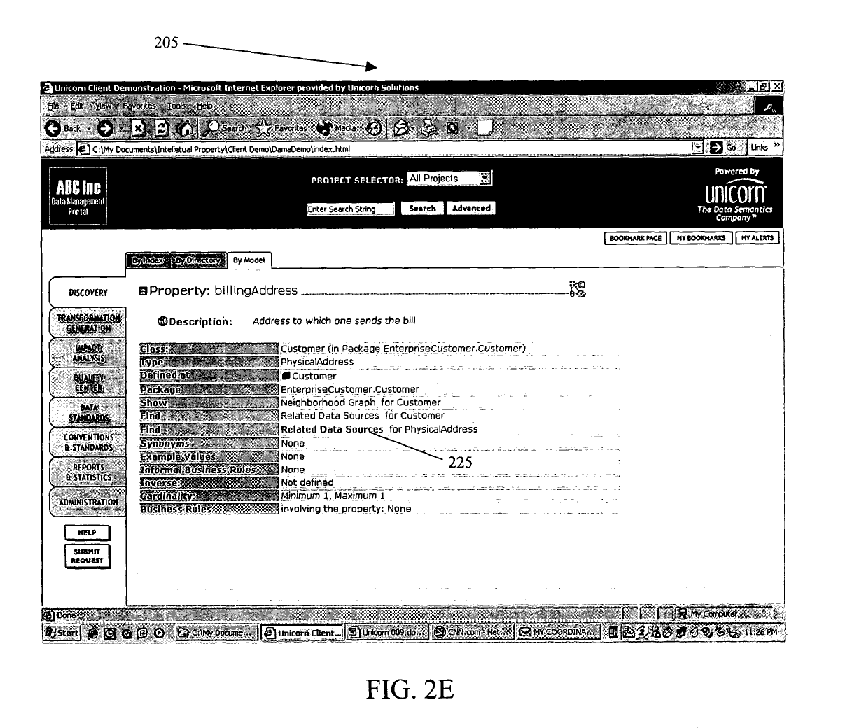

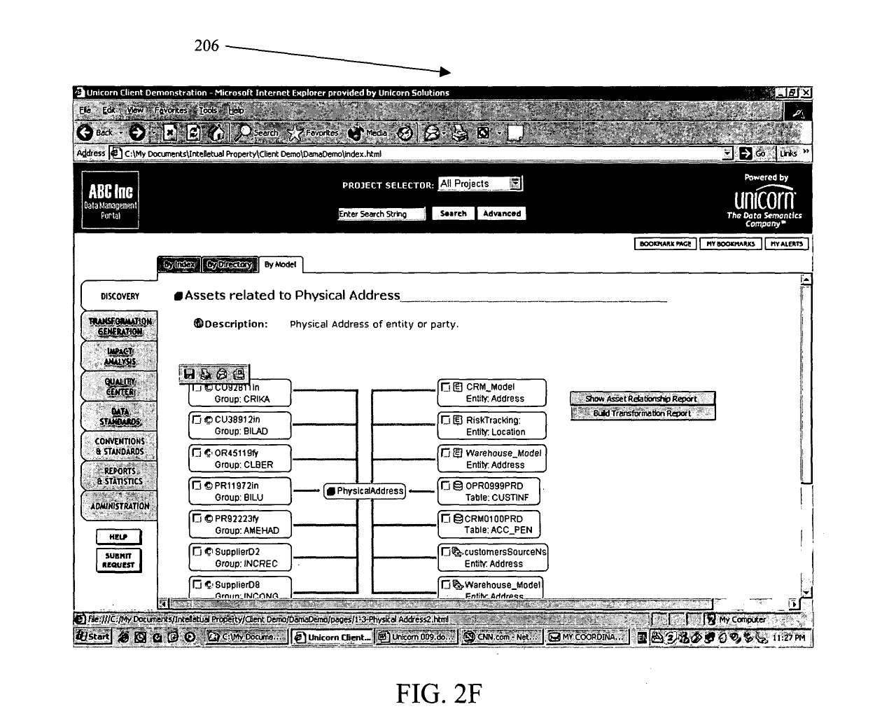

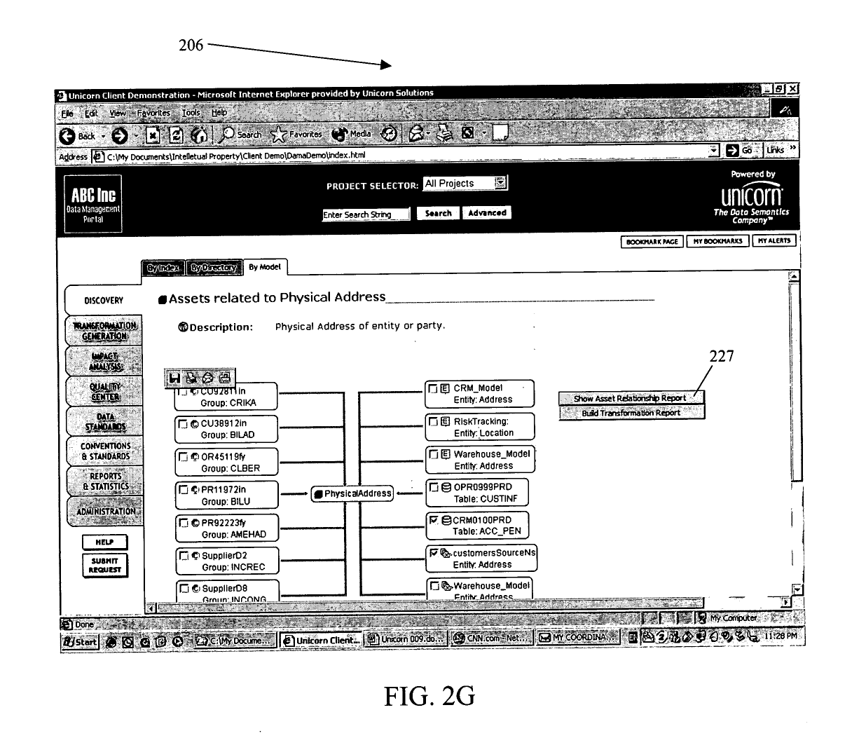

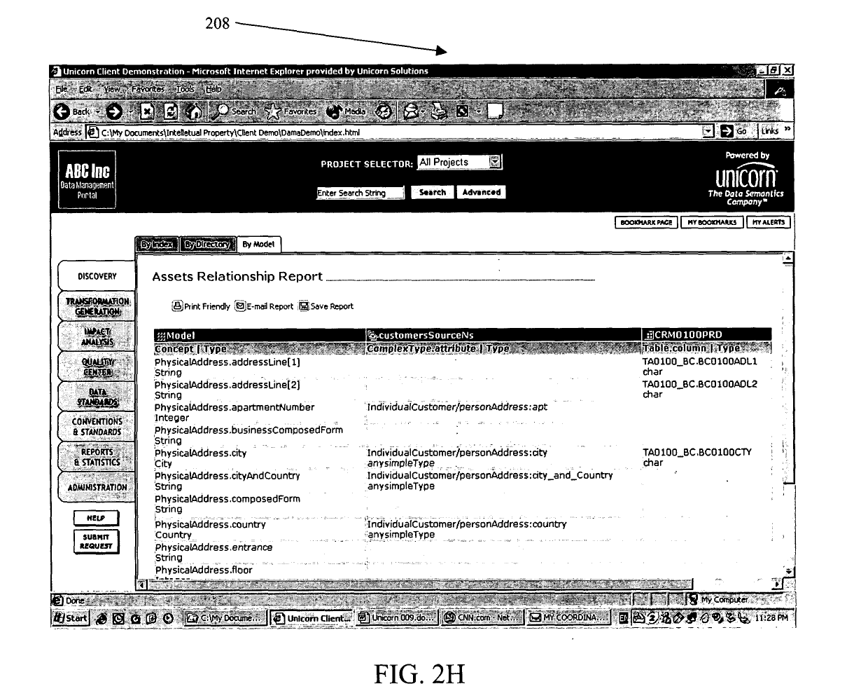

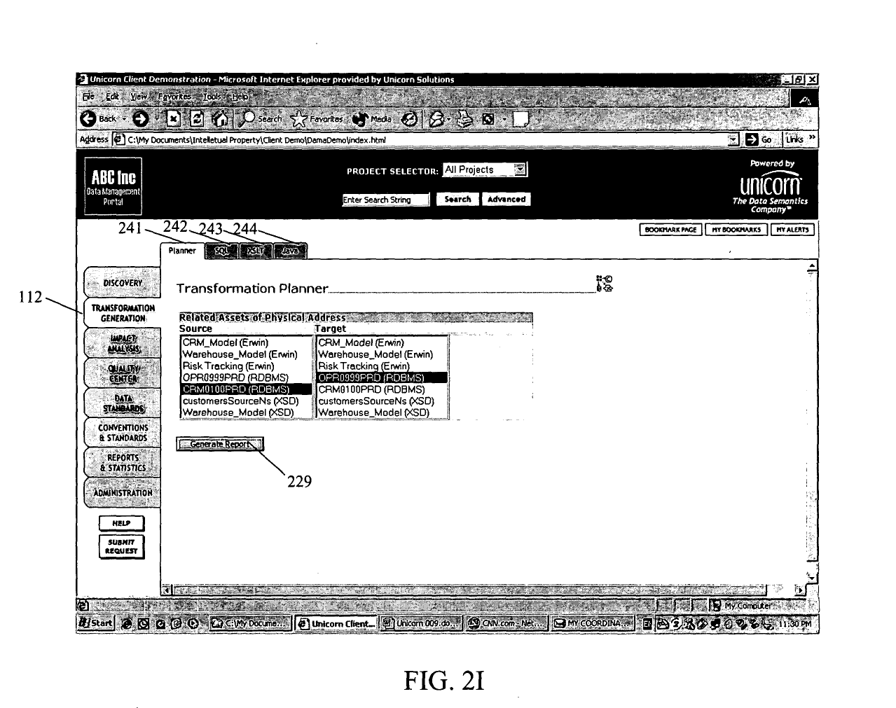

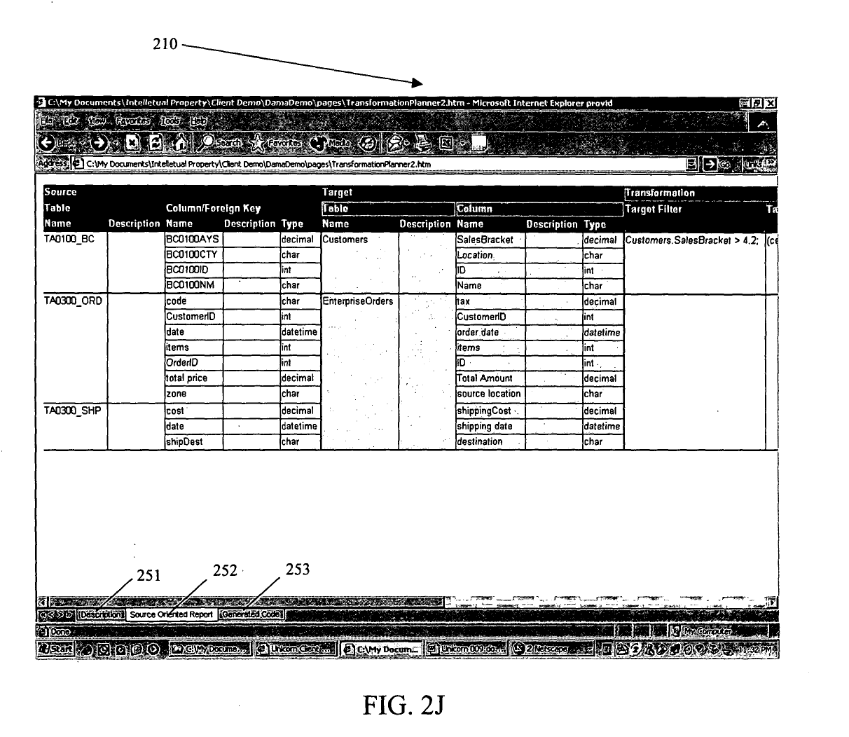

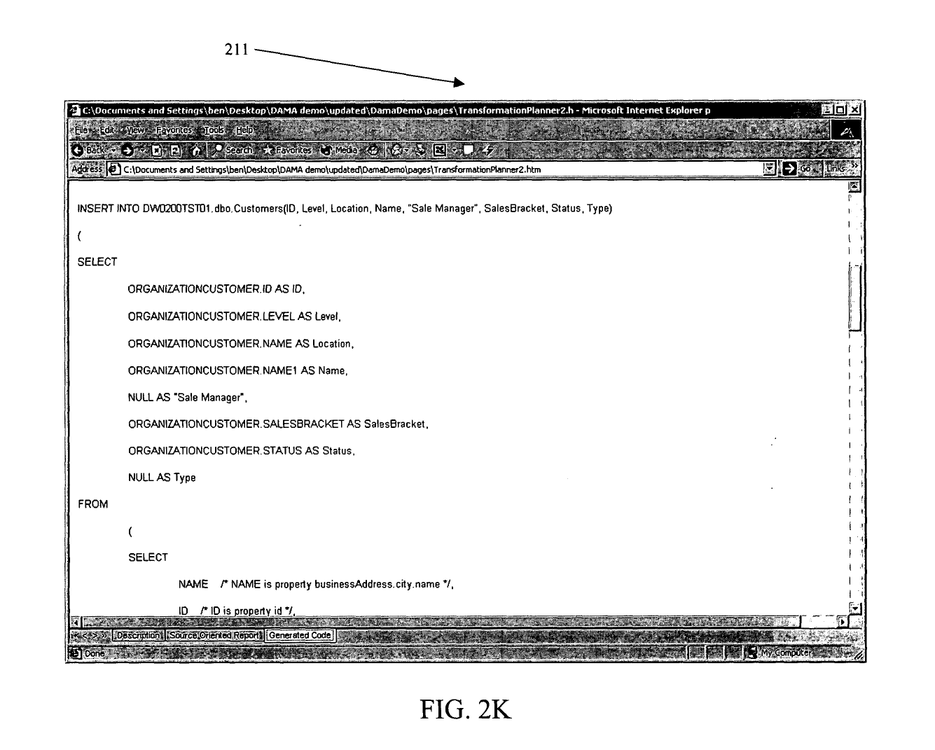

a “Transformation Generation” tab 112, for asset metadata processing, as illustrated in FIGS. 2A-2K;

a “Impact Analysis” tab 113, for understanding the impact of changes to a data asset on the entire repository;

a “Quality Center tab 114, for deriving instructions to validate compliance of asset data with business rules;

a “Data Standards” tab 115, for searching the enterprise repository;

a “Conventions & Standards” tab 116, for viewing a thesaurus of business language semantics to understand the enterprise repository;

a “Reports & Statistics” tab 117, for generating reports about the enterprise repository; and

a “Administration” tab 118, for managing users of the viewer and interrogation application and their privileges.

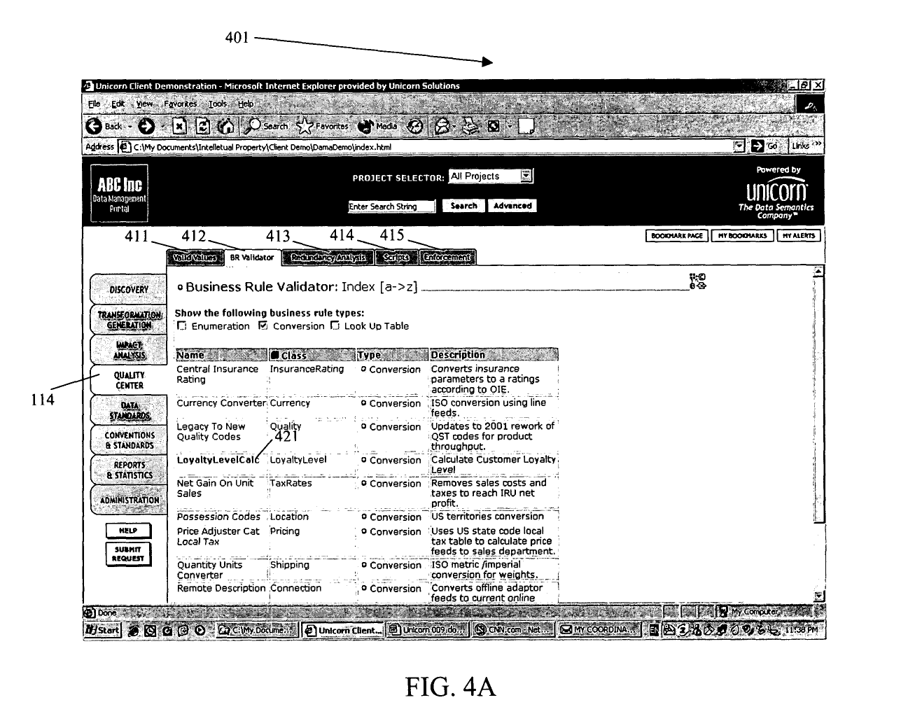

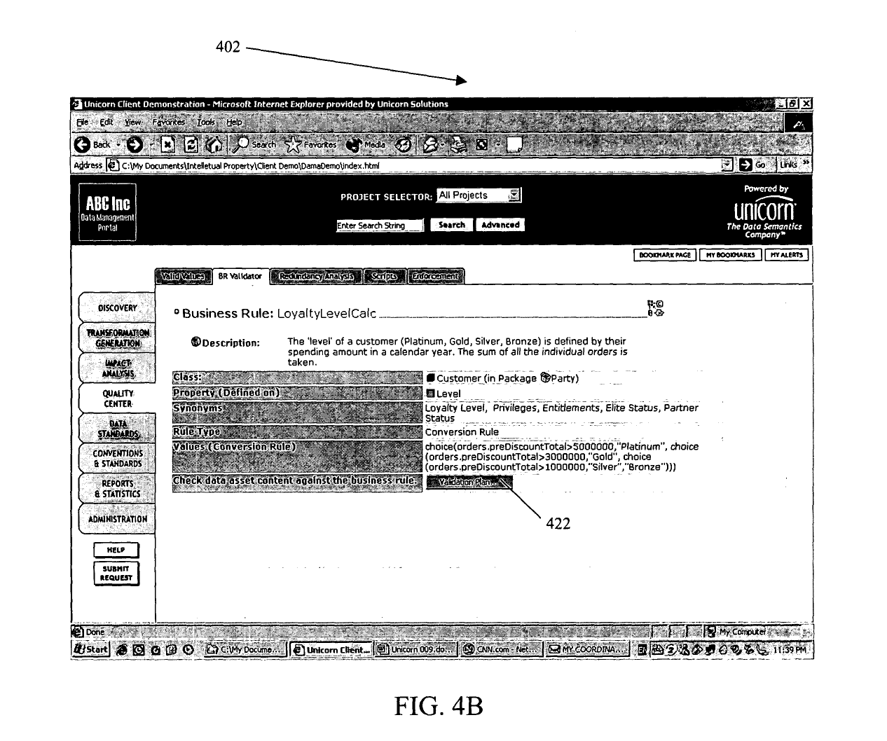

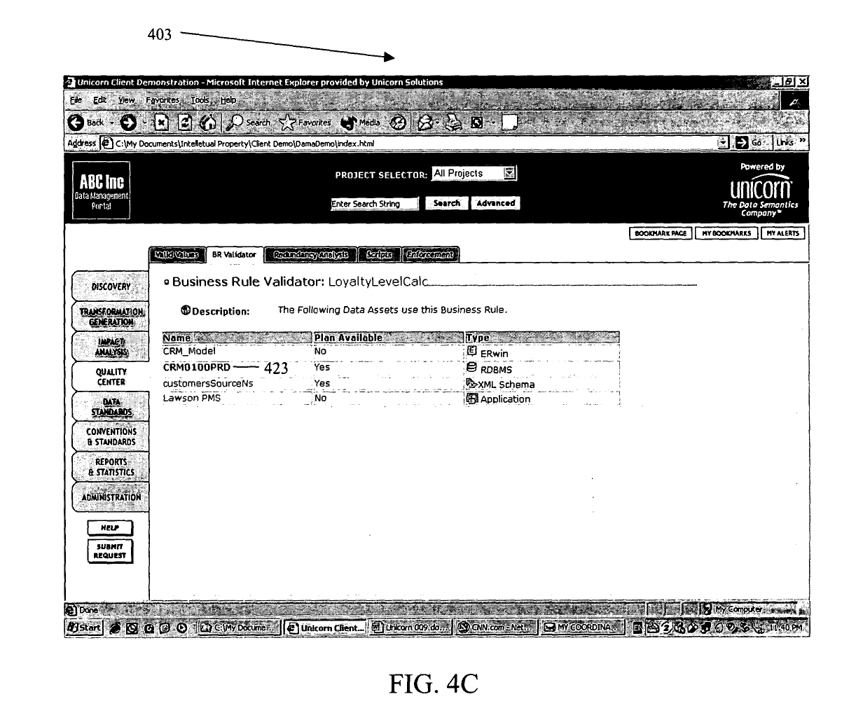

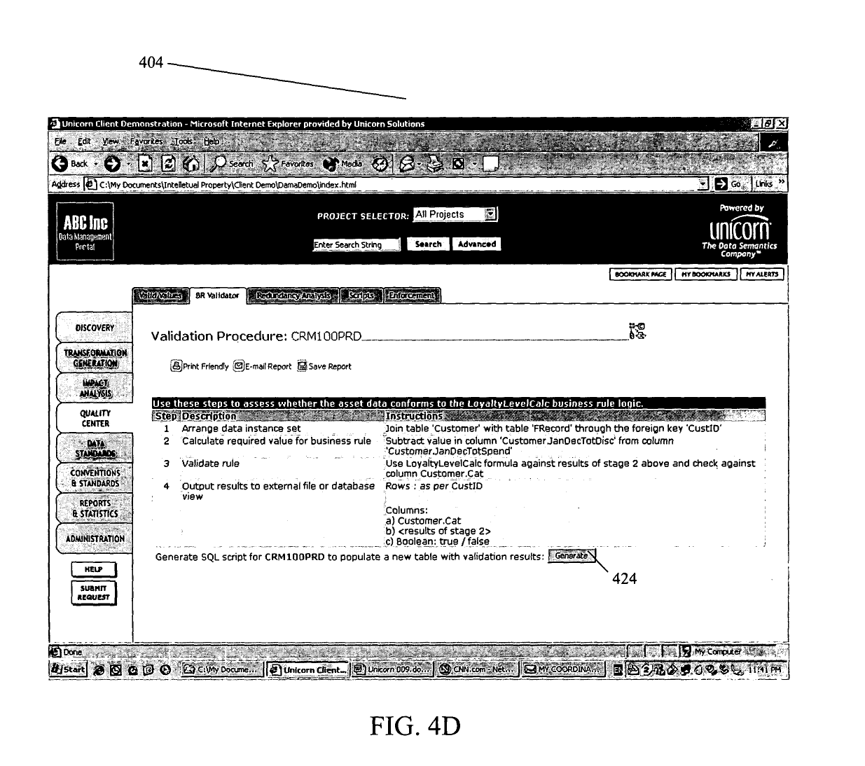

It may be appreciated that in addition to static viewing of an enterprise metadata repository, the viewer & interrogation client of the present invention also enables a user to perform active operations on the repository. Thus, for example, the present invention generates SQL and XSLT scripts for transforming enterprise data, as illustrated hereinbelow in FIG. 2K, and generates validation script for verifying compliance of enterprise data with business rules, as illustrated hereinbelow in FIG. 4D.

Screen 101 opens in response to a user selecting Discovery tab 111. Screen 100 displays an enterprise asset metadata repository. Shown in screen 100 are tabs 121-123 for three different repository displays, as follows:

a “By Index” tab 121, for listing the repository asset metadata and their constructs according to an index;

a “By Directory” tab 122, shown selected in FIG. 1A, for displaying the repository according to packages; and

a “By Model” tab 123, for displaying the repository according to the information model.

Preferably, screen 101 includes auxiliary buttons 131 and 132 for bookmarking a page within the viewer & interrogation application, and for opening a bookmarked page, respectively.

Preferably, screen 101 also includes a “Help” button 140 for accessing documentation for the viewer & interrogation application.

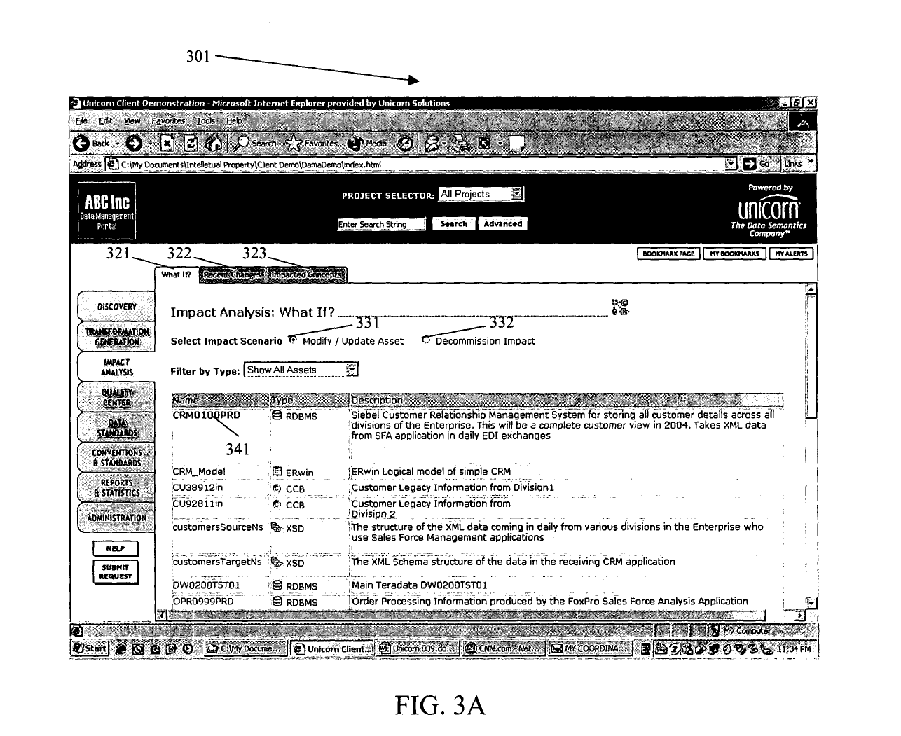

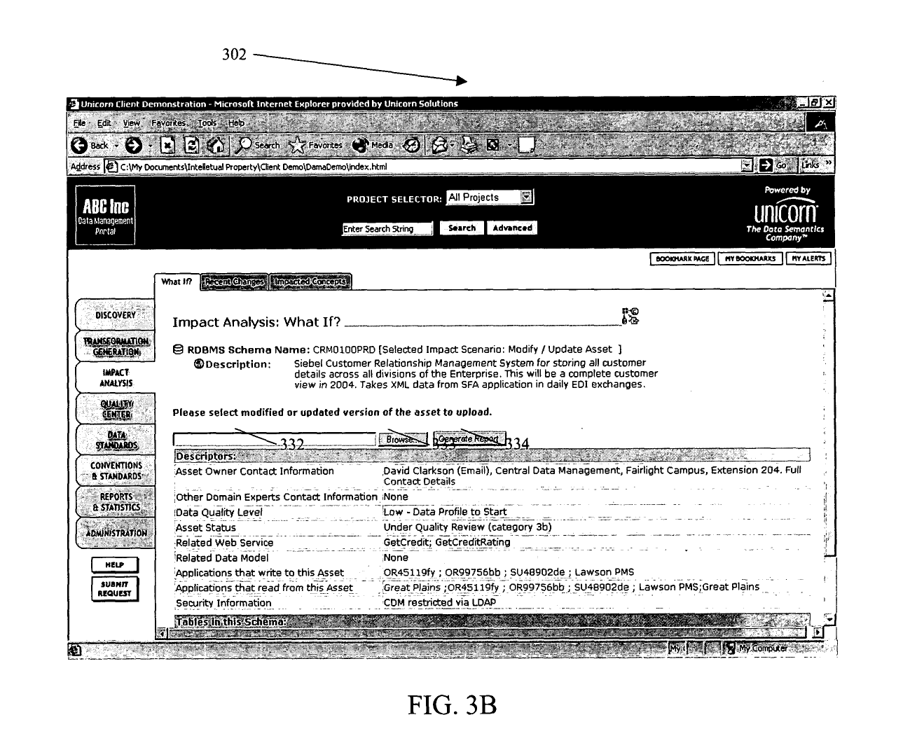

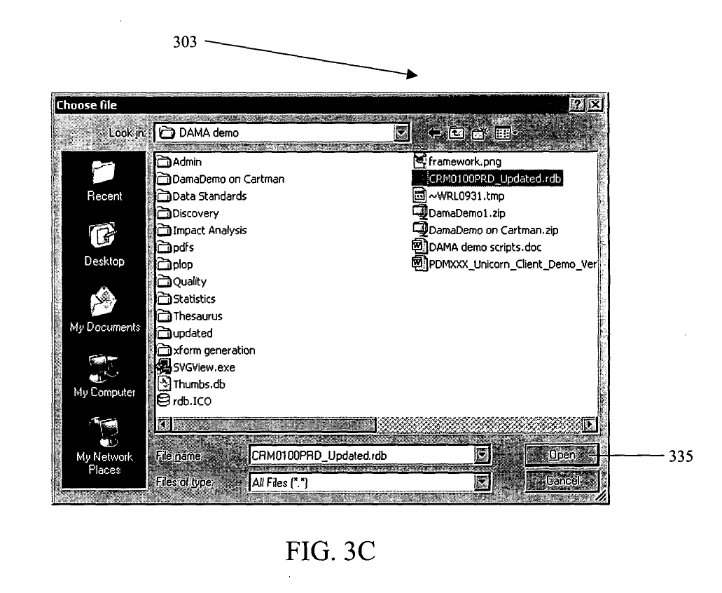

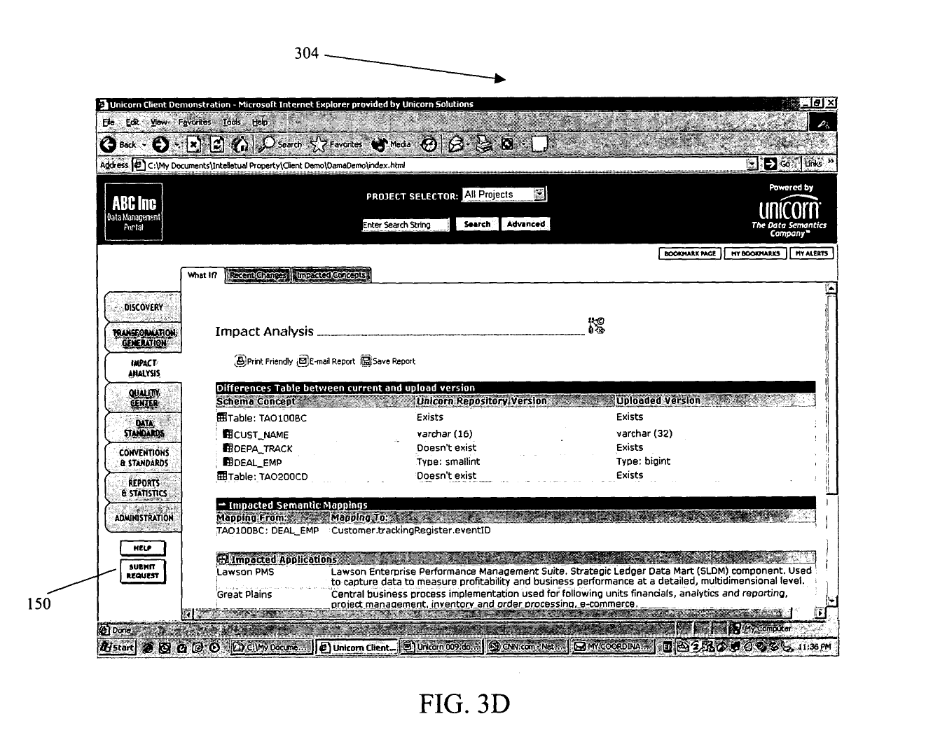

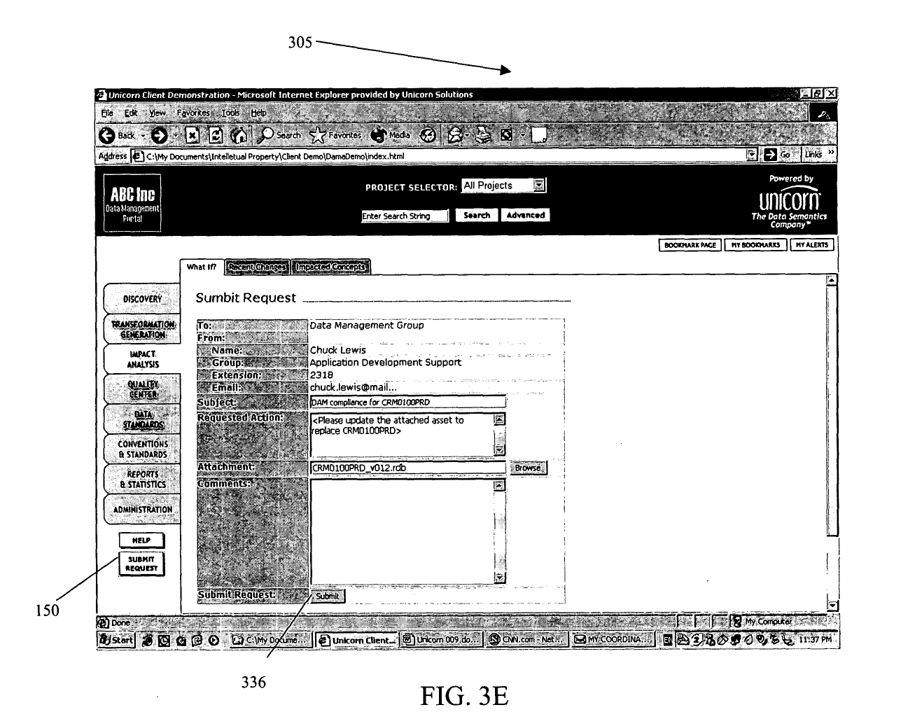

In a preferred embodiment, the present invention separates modeling & construction of an enterprise metadata repository, from viewing & interrogating the repository. As such, the viewer & interrogation tool of the present invention does not empower a user to modify asset metadata. For this purpose, a “Submit Request” button 150 is preferably provided, to submit a change request to an administrator, who can then implement a change on behalf of the submitter, as described below with reference to FIG. 3E. Similarly, a “My Alerts” button 160 is preferably provided, for a user to receive notification when asset metadata is changed.

Repository metadata constructs are preferably represented by distinctive graphical icons, such as icon 171 for a closed package, and icon 172 for an open package.

Preferably, packages listed in screen 101 are linked, so that a user can view the package contents by clicking on the name of a package. Thus, if a user wishes to view contents of a “Customer” package, he clicks on link 180, in response to which screen 102 illustrated in FIG. 1B is displayed.

Screen 102 of FIG. 1B conveniently displays contents of the “Customer” package, including a description of the package, assets for which metadata is included within the package, ontology classes of the information model included within the package, and sub-packages of the package. Several distinctive icons are used to represent the various items listed within screen 102, as follows:

an icon 173 for a descriptor;

an icon 173 for an XML schema;

an icon 174 for a Cobol Copybook;

an icon 175 for a relational database schema;

an icon 176 for an ER logical model; and

an icon 177 for an ontology class.

Preferably, items listed in screen 102 are linked, so that a user can view their contents by clicking on the name of an item. Thus, if a user wishes to view contents of “CRM_Model”, an ERWin logical model for customer relationship management, he clicks on link 182, in response to which screen 103 illustrated in FIG. 1C is displayed.

Screen 103 of FIG. 1C displays a list of entities within the CRM_Model ERWin logical model, designated by icons 178, and descriptors about the model. Preferably, items listed in screen 103 are linked, so that a user can view their contents by clocking on the name of an item. Thus, if a user wishes to view details of the CRM_Model, he clicks on link 183, in response to which screen 104 illustrated in FIG. 1D is displayed.

Screen 104 of FIG. 1D displays an entity-relationship diagram, showing details of the CRM_Model, including its entities, their attributes, and its relationships. Preferably, components of the ER diagram in FIG. 1D are linked, so that a user can drill down and view details by clicking on a component. Thus, if a user wishes to drill down to the tcUser entity, he clicks on link 184, in response to which screen 105 illustrated in FIG. 1E is displayed.

Screen 105 of FIG. 1E displays attributes of the tcUser entity, and the properties of the information model, designated by icons 179, to which they are mapped. For example, the attribute “vchrcity” of entity tcUser is mapped to the ontology property “address.city.name”, of the ontology class “individual Customer”.

Reference is now made to FIGS. 2A-2K, which are illustrations of a user interface for data integration, in accordance with a preferred embodiment of the present invention. Screen 201 of FIG. 2A preferably opens in response to a user clicking on the “Discovery” tab 111 and the “By Model” tab 123. Correspondingly, a list of ontology classes of the global information model are displayed. Ontology classes are displayed hierarchically, so that subclasses appear underneath their respective superclasses. Preferably, classes listed in FIG. 2A are linked, so that a user can view details of a class by clicking on its name. Thus, if a user wishes to view details of the “Customer” class, then he clicks on link 221, in response to which screen 202 illustrated in FIG. 2B is displayed.

Screen 202 of FIG. 2B displays descriptors for class “Customer”, and a table listing its properties, their types and descriptions. A user may view the information model graphically, instead of by list and table, by clicking on a “Graphical View of Model” link 222, in response to which screen 203 illustrated in FIG. 2C is displayed.

Screen 203 of FIG. 2C preferably displays a UML-type diagram, with classes designated by nodes, and with properties and class inheritance designated by arrows. Preferably the diagram illustrated in screen 203 is in a scalable vector graphics (SVG) image format, which can be interactively navigated by familiar pan and zoom operations using an SVG viewer, such as the SVG viewer available from Adobe Systems Incorporated of San Jose, Calif. For example, screen 204 of FIG. 2D illustrated an expanded zoomed-in view of the information model, displaying a node for a “Customer” class. Preferably, the graphical node for “Customer” is linked to screen 202 (FIG. 2B), so that a user can see detailed information about a particular class by clicking on its node within the model diagram.

Referring back to screen 202 of FIG. 2B, preferably listed properties are linked, so that a user can view details of a property by clicking on its name. Thus, if a user wishes to view details of the “billingAddress” property, he clicks on link 223, in response to which screen 205 illustrated in FIG. 2E is displayed.

Screen 205 of FIG. 2E includes descriptors of the “billingAddress” property. For example, “billingAddress” is a property of class Customer with type of class PhysicalAddress. Moreover, “billingAddress” is defined with a package named “EnterpriseCustomer.Customer; i.e., a sub-package “Customer” of package “EnterpriseCustomer”. Preferably, items listed in screen 205 are linked, so that a user can view details of an item by clicking on its name. Thus, if a user wishes to see data assets that include constructs mapped to class “PhysicalAddress”, he can click on link 225, in response to which screen 206 illustrated in FIG. 2F is displayed.

Screen 206 of FIG. 2F displays various assets within the enterprise repository, and constructs thereof which are mapped to the class “PhysicalAddress” in the information model. For example, a group “CRIKA” of a Cobol Copybook named “CU92811in”, an entity “Address” of an ER logical model named “CRM_Model”, a table “CUSTINF” of a relational database named “OPR0999PRD”, and a complex type “Address” of an XML schema named “Warehouse_Model” are all mapped to class “PhysicalAddress” in the information model.

More generally, it may be appreciated by those skilled in the art that the present invention can be used to discover data assets that correspond to a prescribed data asset. Moreover, the nature of the correspondence can also be prescribed. The following are a few different ways data discovery can be performed.

Discover assets that correspond to a prescribed data asset, in the sense that the corresponding data is represented the same way; for example, an ontology property CStaff.name corresponds to an RDBS table column TEmployee.name, and is represented the same way.

Discover assets that correspond to a prescribed data asset, in the sense that the corresponding data is represented in an equivalent way; for example, uppercase vs. lowercase.

Discover assets that are logically dependent on a prescribed asset metadata; for example, “distance” depends logically on “velocity”, since

distance=velocity*time.

Discover data assets upon which a prescribed asset metadata is logically dependent; for example, “velocity” depends logically on “distance” and on “time”,

distance=velocity*time.

Discover data assets that correspond with a prescribed asset metadata, and have a more specific context; e.g. “housingContracts” correspond with “contracts” and are specific to a real estate context.

Discover data assets that correspond with a prescribed asset metadata, and have a more general context; e.g., “contracts” correspond with “housingContracts” and have a more general context than real estate.

Discover data assets that comprise data corresponding with a prescribed asset metadata; for example, “address” comprises “street”.

Discover data assets that correspond with data comprised within a prescribed asset metadata; for example, “street” is comprised within “address”.

Using screen 206, a user can create comparison reports between data assets. For example, FIG. 2G shows screen 206 with two of the data assets' checkboxes checked; namely, a checkbox for the relational database schema “CRM0100PRD” and a checkbox for the XML schema “customersSourceNs”. By clicking on a “Show Asset Relationship Report” link 227, the user indicates that he wishes to see a report comparing the two selected assets, and, in response, screen 208 of FIG. 2H is displayed.

Screen 208 of FIG. 2H displays a comparison of the selected assets, vis a vis the information model. Shown in the left-hand column are constructs of the information model. In each row there appears a construct of the information model and constructs corresponding thereto from the XML schema “CustomersSourceNs” and from the relational database “CRM0100PRD”. For example, the ontology property “PhysicalAddress.city” from the information model corresponds to the element “city” of the complex type “IndividualCustomer/personAddress” from the XML schema, and to the field “BC0100CTY” of table “TA0100_BC” from the relational database schema.

It may be appreciated by those skilled in the art that the asset relationship report illustrated in FIG. 2H may be generated based on various forms of correspondences, as described hereinabove with respect to FIG. 2F and data discovery. For example, an asset comparison report may compare metadata of one asset that generalizes metadata of another asset to a more general context, or that specializes metadata of another asset to a more specialized content.

The present invention is preferably used for generation of data transformations, to convert data from one schema to another. A user accesses this capability by clicking on “Transformation Generation” tab 112, in response to which screen 209 of FIG. 2I is displayed. Screen 209 includes four tabs, as follows:

a “Planner” tab 241, shown selected in FIG. 2I, for viewing logistics of a desired transformation;

an “SQL” tab 242, for generating SQL script for a desired transformation that operates on relational database tables;

an “XSLT” tab 243, for generating XSLT script for a desired transformation that operates on XML documents;

a “Java” tab 244, for generating Java script for a desired transformation that operates on an arbitrary schema.

As shown in FIG. 2I, to generate a desired transformation, a user selects a source asset schema and a target asset schema. For example, as shown in FIG. 2I, a source relational database schema “CRM0100PRD” and a target relational database schema “OPR0999PRD” are selected. To generate a plan for the desired transformation, the user clicks on a “Generate Report” button 229, in response to which screen 210 of FIG. 2J is displayed.

Screen 210 of FIG. 2J illustrates logistics of a desired data transformation. Preferably, the logistics are embedded within a spreadsheet, as illustrated in FIG. 2J, which uses a Microsoft Excel spreadsheet. At the left of the spreadsheet appear tables and fields, or columns, of the source relational database schema; and to their right appears tables and columns of the target relational database schema. At the right of the spreadsheet are descriptions of operations that the desired transformation is to perform, in a generic pseudo-code language.

At the bottom of screen 210, three tabs are provided, as follows:

a “Description” tab 251, for displaying descriptors of a transformation;

a “Source Oriented Report” tab 252, shown selected in FIG. 2J, for displaying a spreadsheet planner for a transformation; and

a “Generated Code” tab 253, for displaying SQL, or another language script, for performing a transformation. Such script can be run within the appropriate database schema, to perform the transformation on the actual data itself.

When a user clicks “Generate Code” tab 253, screen 211 of FIG. 2K is displayed in response.

Screen 211 of FIG. 2K displays SQL script for transforming data from the source relational database schema to the target relational database schema. Such script may be copied to a standard relational database management system, and executed therein.

It is noted that while the viewer & interrogation application of the present invention enables a user to generate transformation scripts, it preferably does not empower the user to modify the information model, or the enterprise data assets, or the mappings from the assets into the information model.

Reference is now made to FIGS. 3A-3E, which are illustrations of a user interface for impact analysis, in accordance with a preferred embodiment of the present invention. Shown in FIG. 3A is a screen 301, displayed in response to a user clicking “Impact Analysis” tab 113. Screen 301 includes three tabs, as follows:

a “What if?” tab 311, shown selected in FIG. 3A, for determining impacts specified changes to metadata would have on an entire enterprise asset metadata repository;

a “Recent Changes” tab 312, for viewing recent changes made to an enterprise asset metadata repository; and

an “impacted Concepts” tab 313, for viewing constructs impacted by recent changes to an enterprise metadata repository.

Additionally, screen 301 includes two selection buttons, as follows:

a “Modify/Update Asset” button 321, shown selected in FIG. 3A, for determining impacts to an enterprise asset metadata repository due to asset metadata modification; and

a “Decommission Impact” button 322, for determining impacts to an enterprise asset metadata repository due to removal of asset metadata.

Shown in screen 301 is a list of inter-related enterprise data assets. Impact analysis determines what would happen to enterprise data if asset metadata were to be modified in a specified way. Impact analysis is a very important tool, since changes to asset metadata often lead to subtle ill-defined conditions for other asset metadata.

A user who wants to determine the impact of changing a relational database schema for a database named “CRM0100PRD” clicks on a link 331 within screen 301, in response to which screen 302 is displayed.

Screen 302 of FIG. 3B includes descriptors for the selected database schema for “CRM0100PRD”. It is noted that the descriptors preferably include names of external applications that read or write to the CRM0100PRD database. Although such applications may be outside the scope of the client viewer & navigation tool, nevertheless they are included within the impact analysis as long as the enterprise repository includes information about them.

Screen 302 includes a text box 332 for specifying a location within a file directory of a relational database schema which is to substitute for CRM0100PRD. Preferably, text box 332 is filled with the assistance of a file system browser, activated by a “Browse” button 333. After text box 332 is filled, impact analysis is activated by a “Generate Report” button 334.

Screen 303 of FIG. 3C illustrates a file system browser, activated by “Browse” button 333 of FIG. 3B, used to select a substitute relational database schema stored within a file named “CRM0100PRD_Updated.rdb”, which is located within a directory named “DAMA demo”. The user selects the substitute relational database by clicking on “Open” button 335, which brings up screen 302 of FIG. 3B in response, having text box 332 filled in with the filename and path for the substitute relational database schema. Screen 304 of FIG. 3D is then displayed in response to the user clicking on “Generate Report” button 334.

Screen 304 of FIG. 3D includes (i) a list of differences encountered between the original and substitute relational database schemas for CRM01000PRD; and (ii) a list of impacted mappings, applications, data sources and transformation scripts. Although preferably the user cannot implement the change of replacing CRM01000PRD with CRM01000PRD_Updated, he nevertheless can automatically issue a change request to administrators of the system, for this change to be made, by clicking on “Submit Request” tab 150. In response, screen 305 of FIG. 3E is displayed, which includes a template for an e-mail message to a Data Management Group with an update request. By clicking on a “Submit” button 336, the user's request is submitted to the appropriate authorities. In a preferred embodiment of the present invention, the user is alerted to changes made in the enterprise repository by clicking on “My Alerts” button 150. Alternatively, or additionally, the user may be notified through e-mail messages.

Reference is now made to FIGS. 4A-4D, which are illustrations of a user interface for data quality, in accordance with a preferred embodiment of the present invention. Shown in FIG. 4A is a screen 401 which is displayed in response to a user clicking on “Quality Center” tab 114. Screen 401 includes tabs as follows:

“Valid Values” tab 411, for performing type checking on data values;

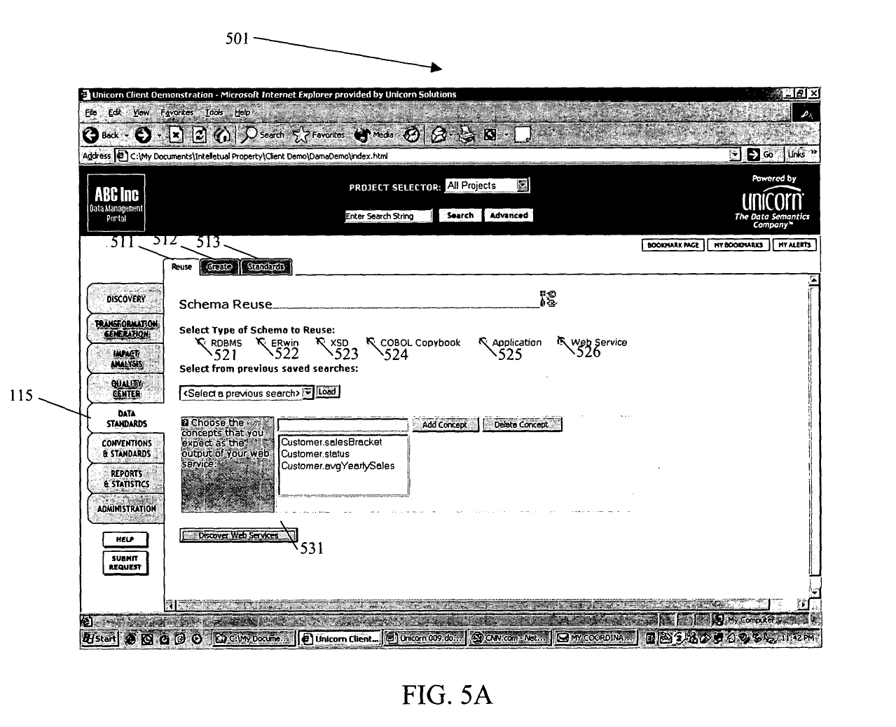

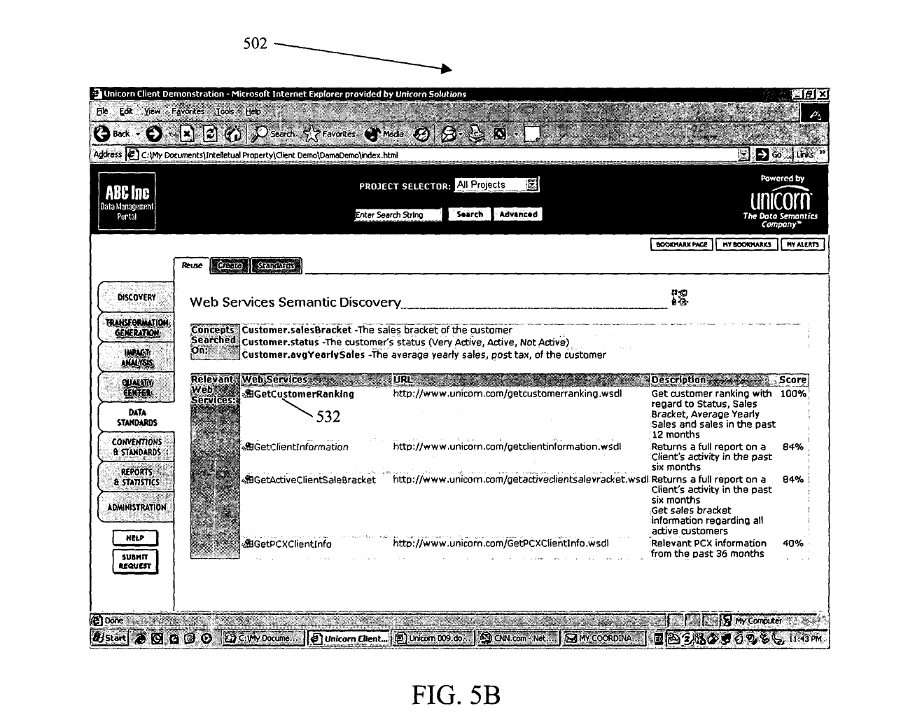

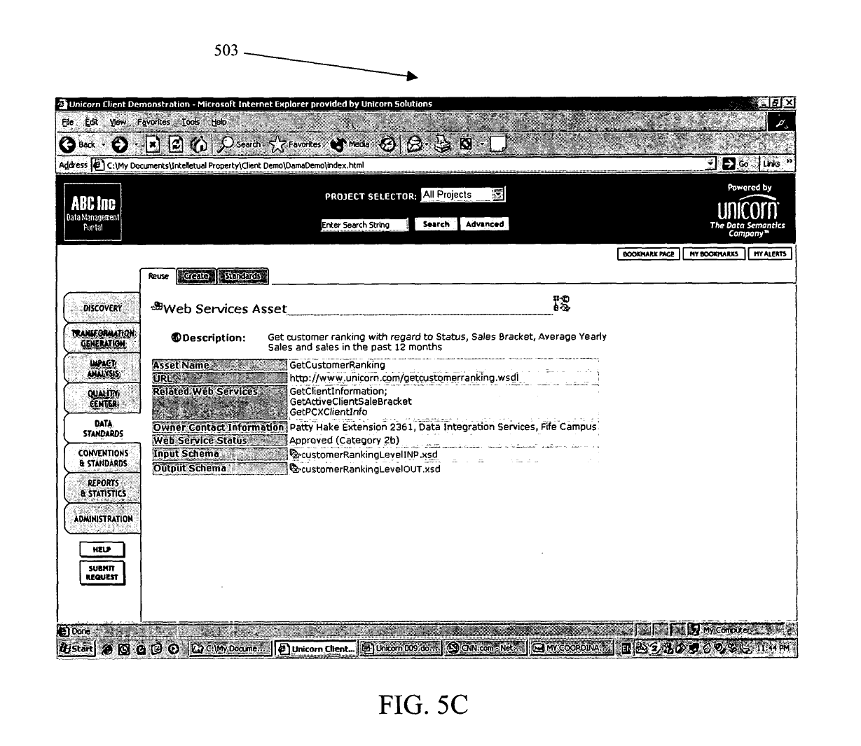

a “BR Validator” tab 412, shown selected in FIG. 5A, for validating compliance with business rules;

a “Redundancy Analysis” tab 413, for analyzing redundancy within the enterprise data assets;

a “Scripts” tab 414, for generating scripts to perform validation within appropriate database management systems; and

an “Enforcement” tab 415, for enforcing compliance with business rules.

Business rules refer to constraints on data values, and interrelationships between data values, within enterprise assets. For example, business rules include enumerations of allowable values for data, such as for days of the week, and conversion formulas between data, such as from feet to meters. In a preferred embodiment of the present invention, business rules apply to properties of ontology classes within the global information model.

Shown in screen 401 is a list of business rules, the ontology classes on which they are defined, their types and a description thereof. For example, a business rule named “Central Insurance Rating” applies to properties of ontology class InsuranceRating, and converts insurance parameters to ratings. Preferably, business rules displayed in screen 401 are linked, so that a user can see details of a business rule by clicking on its link. Thus, when a user clicks on a link 421 for the “LoyaltyLevelCalc” business rule, screen 402 of FIG. 4B is displayed in response.

Screen 402 of FIG. 4B shows details of business rule “LoyaltyLevelCalc”, from which is can be seen that this business rule is used to convert a property preDiscountTotal of class ontology to one of three levels: “Platinum”, “Gold”, “Silver” and “Bronze”, based on corresponding totals of 5,000,0000, 3,000,000 and 1,000,000. To generate instructions for validating compliance with this business rule throughout the enterprise repository, the user clicks on “Validate Plan” button 422, in response to which screen 403 of FIG. 4C is displayed.

Screen 403 of FIG. 4C identifies data assets to which business rule “LoyaltyLevelCalc” applies. Preferably, data assets in listed in screen 403 are linked, so that a user can find details of validating the business rule for a specific data asset by clicking on its link. Thus, when a user clicks on link 423 got the relational database schema “CRM0100PRD”, screen 404 of FIG. 4D is displayed in response.

Screen 404 of FIG. 4D describes a step-by-step procedure for determining whether or not the data in CRM0100PRD is compliant with the LoyaltyLevelCalc business rule. Furthermore, the user can generate SQL script for performing the validation within a database management system, by clicking on “Generate” button 424.

Reference is now made to FIGS. 5A-5C, which are illustrations of a user interface for search and re-use, in accordance with a preferred embodiment of the present invention. Shown in FIG. 5A is a screen 501 that enables a user to run a search on data asset metadata. Screen 501 is displayed in response to a user clicking on “Data Standards” tab 115. Screen 501 includes three tabs, as follows:

a “Reuse” tab 511, shown selected in FIG. 5A, for running an already stored search;

a “Create” tab 512, for creating a new search; and

a “Standards” tab 513, for using a standard search.

Screen 501 also includes buttons for selecting the type of schema to be searched, including

an “RDMS” button 521, for searching among relational database schemas;

an “ERWin” button 522, for searching among entity-relationship logical models;

an “XSD” button 523, for searching among XML schemas;

a “COBOL Copybook” button 524, for searching among Cobol Copybooks;

an “Application” button 525, for searching among external applications; and

a “Web Service” button 526, shown selected in FIG. 5A, for searching among web services.

It is noted with reference to FIG. 5A that web services are a form of data asset. Web Services Description Language (WSDL) is a schema for such an asset. Screen 501 illustrates how a user can search for a web service that processes the ontology properties Customer.salesBracket, Customer.status and Customer.avgYearlySales. After loading or entering search criteria, the user clicks on “Discover Web Services” button 531, in response to which screen 502 of FIG. 5B is displayed.

Screen 502 of FIG. 5B displays web services that at least partially match the search criteria from screen 501. Web services are displayed with a URL that links to the web service, a description of the web service, and a score indicating how well the web service matches the search criteria from screen 501. Preferably, web services are linked, so that a user who wishes to see detailed information about a web service can click on its link. For example, a user can see details of the “GetCustomerRanking” web service by clicking on its link 532, in response to which screen 503 of FIG. 5C is displayed.

Screen 503 includes detailed information about the “GetCustomerRanking” web service, including the input and output schema for the web service.

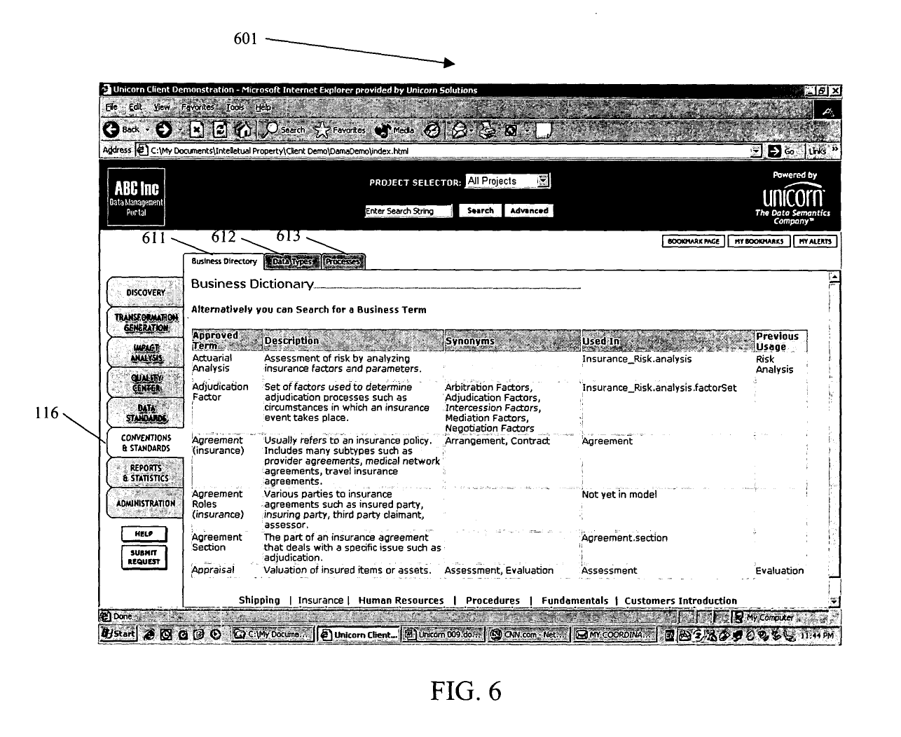

Reference is now made to FIG. 6, which is an illustration of a user interface for a data thesaurus, in accordance with a preferred embodiment of the present invention. Shown in FIG. 6 is a screen 601, displayed in response to a user clicking on “Conventions & Standards” tab 116. Screen 601 includes three tabs, as follows:

a “Business Dictionary” tab 611, shown selected in FIG. 6A, for displaying business terms used within an enterprise data repository;

a “Data Types” tab 612, for displaying data types used within the enterprise repository; and

a “Processes” tab 613, for displaying processes used within the enterprise repository.

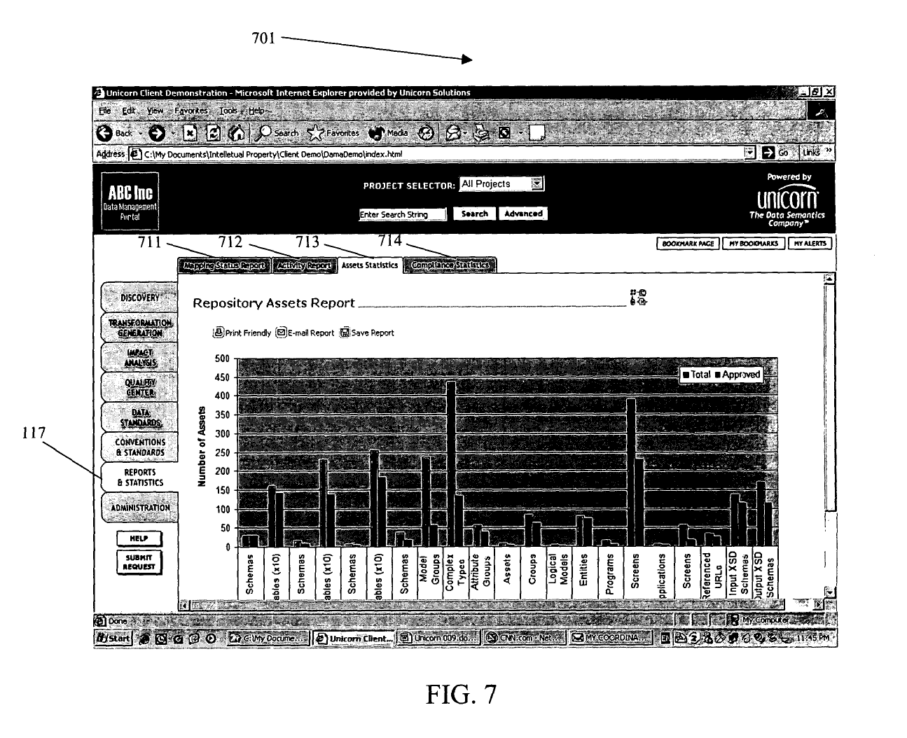

Reference is now made to FIG. 7, which is an illustration of a user interface for data reports, in accordance with a preferred embodiment of the present invention. Shown in FIG. 7 is a screen 701, which is displayed in response to a user clicking on “Reports & Statistics” tab 117, showing a statistical bar graph of numbers of data asset constructs within an enterprise repository. Four tabs are included in screen 701, as follows:

a “Mapping Status Report” tab 711, for showing statistics about mappings from the data assets to the global information model;

an “Activity Report” tab 712, for displaying an activity report;

an “Assets Statistics” tab 713, shown selected in FIG. 7, for showing statistics about data asset constructs; and

a “Compliance Statistics” tab 714, for showing statistic about compliance with business rules.

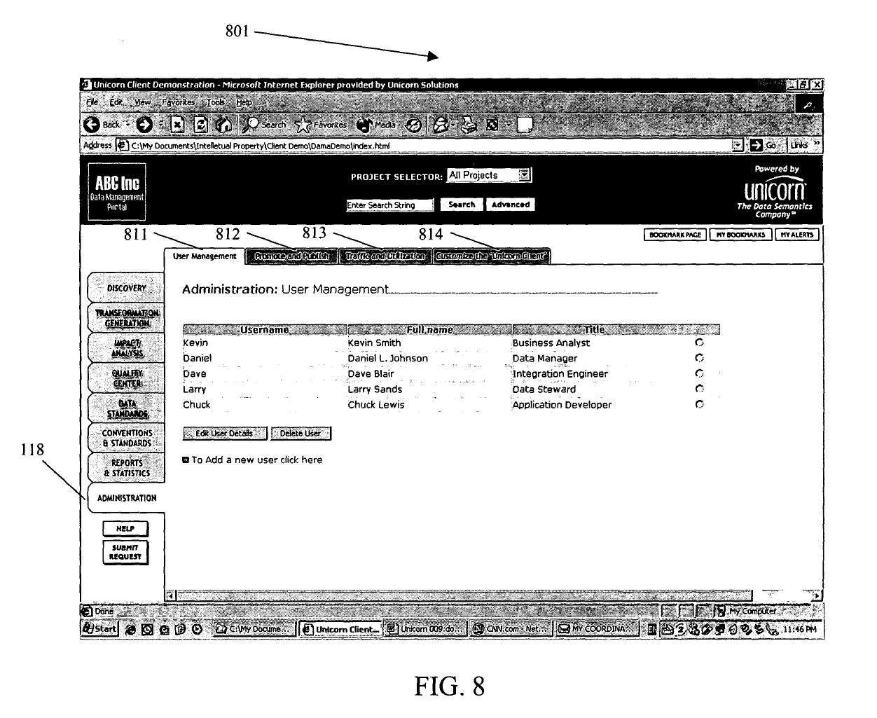

Reference is now made to FIG. 8, which is an illustration of a user interface for data administration, in accordance with a preferred embodiment of the present invention. Shown in FIG. 8 is a screen 801, which is displayed in response to a user clicking on “Administration” tab 118, showing a list of users. Using screen 801, an administrator can add new users, edit details for existing users, and delete users. Four tabs are included within screen 801, as follows:

a “User Management” tab 811, shown selected in FIG. 8, for managing users of the viewer & interrogation application;

a “Promote and Publish” tab 812, for publishing information on the web;

a “Traffic and Utilization” tab 813, for monitoring usage of the system; and

a “Customize the ‘Unicorn Client’ tab 814, for customizing the user interface of the system.

Enterprise Asset Metadata: Modeling & Construction

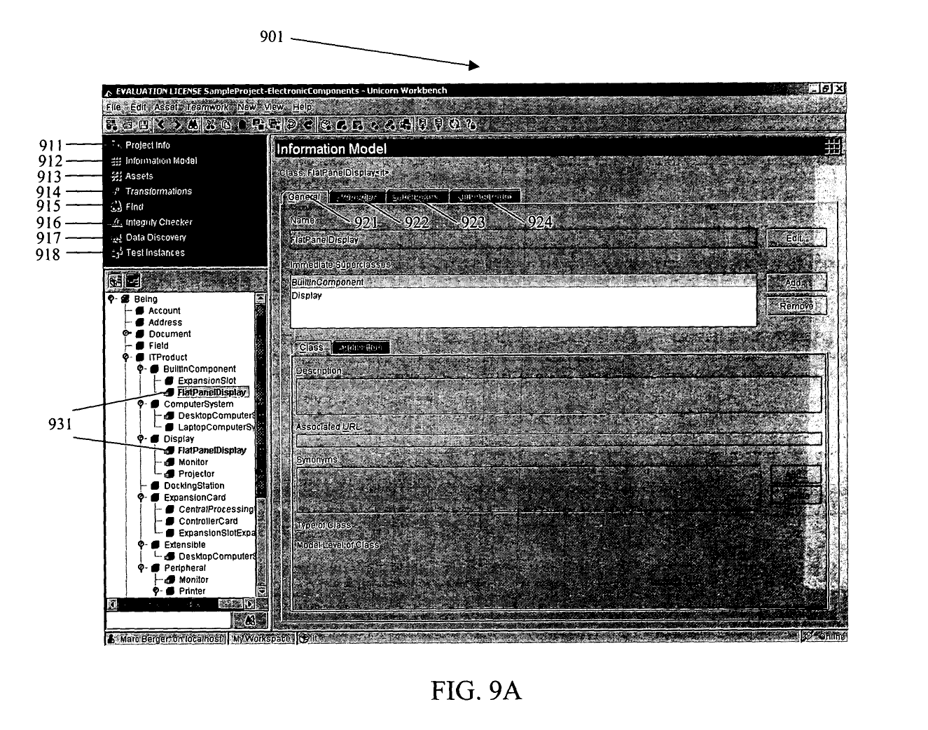

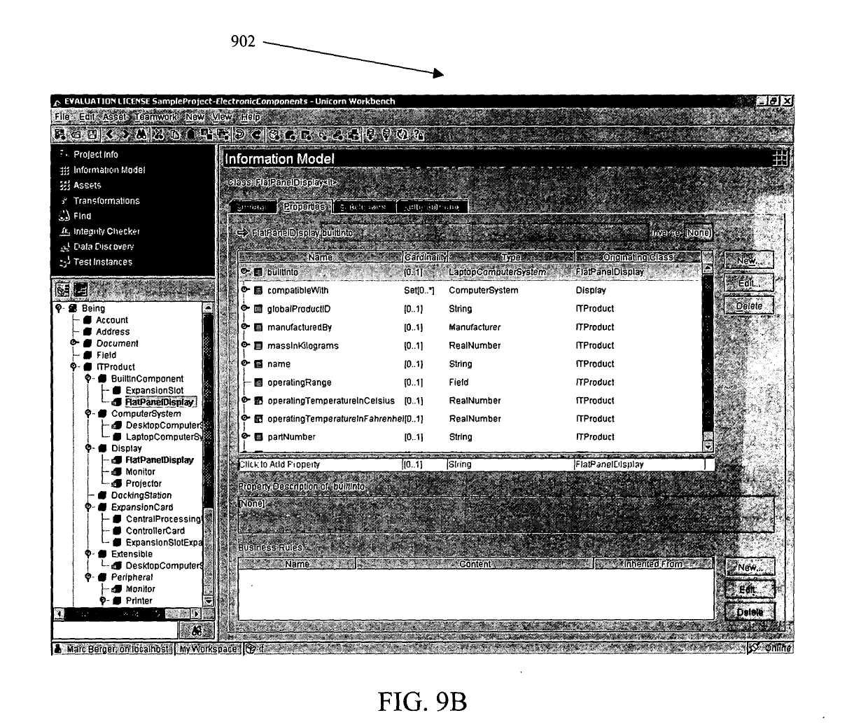

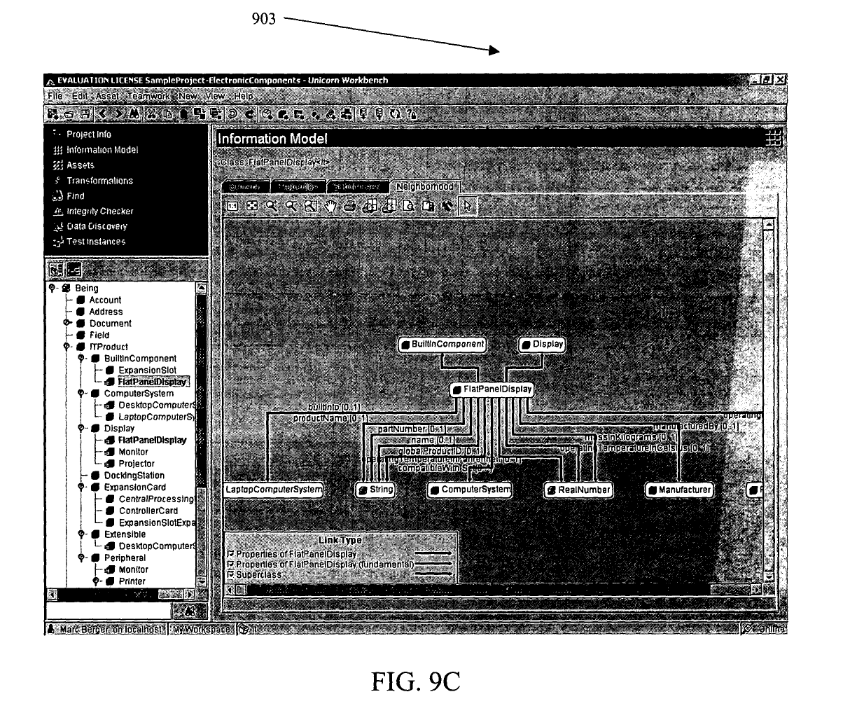

Reference is now made to FIGS. 9A-9C, which are illustrations of a user interface for building an information model, in accordance with a preferred embodiment of the present invention. Shown in FIG. 9A is a screen 901, including icons for eight workflows, as follows:

a “Project Info” icon 911 for information about the overall project;

an “Information Model” icon 912, for building a global information model;

an “Assets” icon 913, for importing assets and defining mappings from assets to the global information model;

a “Transformations” icon 914, for generating data transformations;

a “Find” icon 915, for searching the overall project;

an “Integrity Checker” icon 916, for checking integrity of the project vis a vis data types and business rules;

a “Data Discovery” icon 917, for displaying constructs of the project that are associated through mapping with a specified construct; and

a “Test Instances” icon 918, for generating test data for the project.

Screen 901 is displayed in response to a user clicking on “Information Model” at the top left.

Screen 901 includes a hierarchical list of classes of an ontology model on the left, and a work area for editing the ontology model on the right. The work area includes four tabs, as follows:

a “General” tab 921, shown selected in FIG. 9A, for displaying general properties of a class selected from the list of classes on the left;

a “Properties” tab 922, shown selected in FIG. 9B, for displaying properties of the class selected from the list of classes on the left;

a “Subclasses” tab 923, for displaying subclasses of the class selected from the list of classes on the left; and

a “Neighborhood” tab 924, shown selected in FIG. 9C, for displaying a graphical representation of the class selected from the list of classes on the left and its immediate neighbors.

The class “FlatPanelDisplay” selected from the list of classes in FIG. 9A inherits from two superclasses, a “BuiltInComponent” class, and a “Display” class. As such, a special form 931 of a class icon is used to designate class “FlatPanelDisplay”. Moreover, when a user selects class “FlatPanelDisplay” on the left, it appears twice in bold, as a subclass of “BuiltInComponent” and as a subclass of “Display”.

By clicking on “Properties” tab 922, a user can view properties of class “FlatPanelDisplay”, as shown in screen of FIG. 9B. Screen 902 displays the list of ontology classes on the left, and properties of class “FlatPanelDisplay” on the right. For example, “builtInto” is a property of class “FlatPanelDisplay” with target class “LaptopComputerSystem”; “compatibleWith” is a property that class “FlatPanelDisplay” inherits from superclass “Display” with target class “ComputerSystem”; and “globalProductID” is a property that class “FlatPanelDisplay” inherits from superclass “ITProduct” which is a character string.

By clicking on “Neighborhood” tab 923, a user can view a graphical representation of class “FlatPanelDisplay” and its immediate superclasses and properties, as illustrated in screen 903 of FIG. 9C. Preferably, using screens 901, 902 and 903, the user can modify the information model, for example, by adding new classes and properties, deleting existing classes and properties, modifying classes and properties, adding new inheritance relationships, deleting existing inheritance relationships, and modifying inheritance relationships.

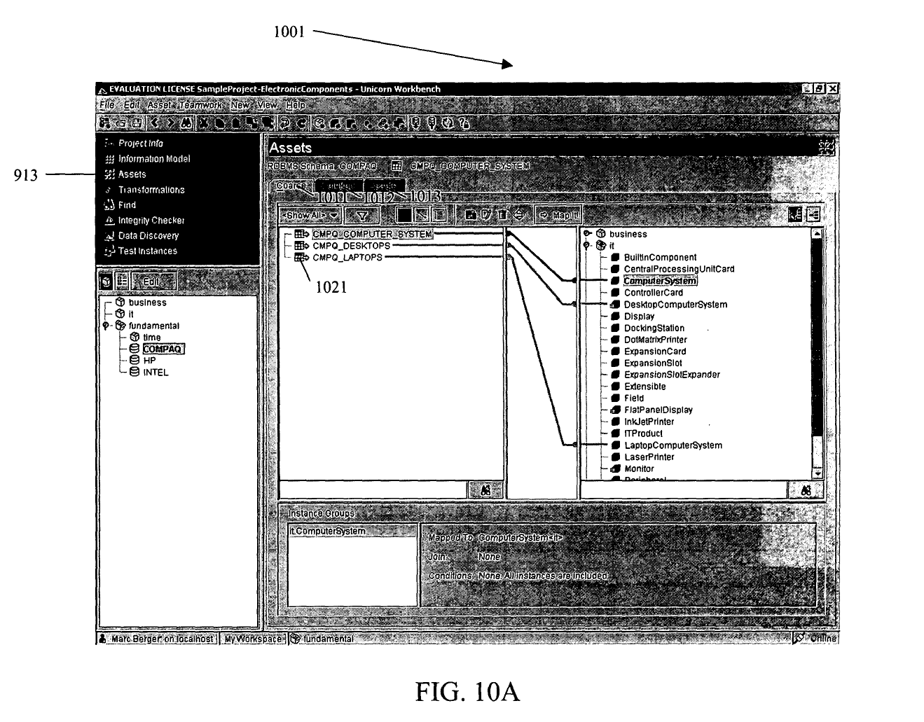

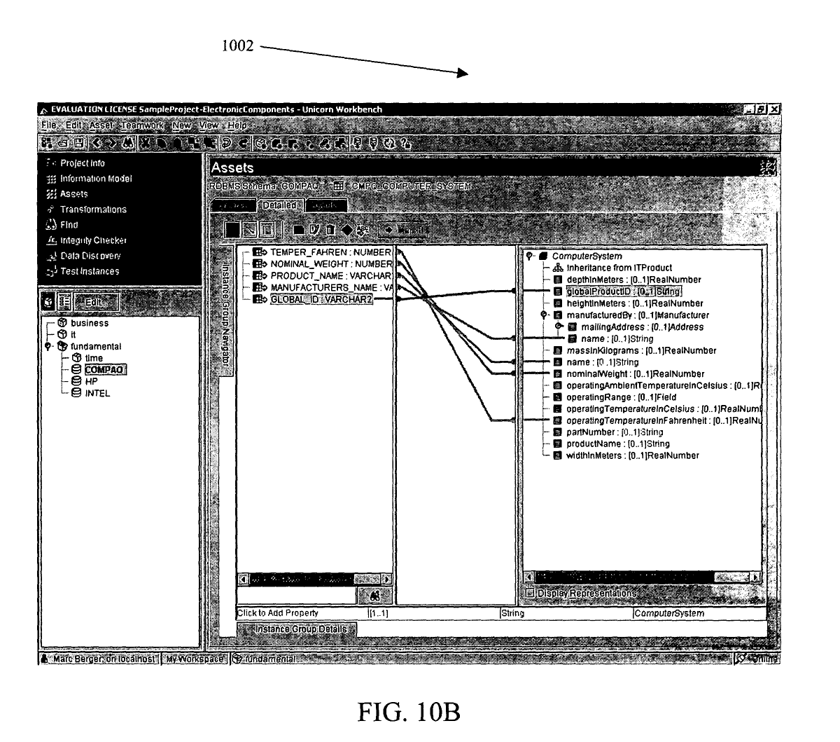

Reference is now made to FIGS. 10A and 10B, which are illustrations of a user interface for mapping assets to an information model, in accordance with a preferred embodiment of the present invention. Screen 1001 of FIG. 10A is displayed in response to a user clicking on “Assets” tab 913. Screen 1001 includes three tabs, as follows:

a “Coarse” tab 1011, shown selected in FIG. 10A, for displaying mappings from composite constructs of data assets to corresponding classes of the information model;

a “Detailed” tab 1012, for displaying mappings from atomic constructs of data assets to corresponding properties of the information model; and

an “Assets” tab 1013, for displaying constructs of a selected data asset.

Shown in screen 1001 are three relational database tables, “CMPQ_COMPUTER_SYSTEM”, “CMPQ_DESKTOPS” and “CMPQ_LAPTOPS”, from within a relational database schema named “COMPAQ”. The three tables are shown mapped to corresponding ontology classes of the information model. For example, the table “CMPQ_COMPUTER_SYSTEM” is mapped to class “ComputerSystem”. Icons 1021, with right-arrows, designated tables that are mapped into the information model.

To see details of the mappings, a user clicks on “Detailed Tab” 926, in response to which screen 1002 of FIG. 10B is displayed. Screen 1001 shows five fields from table “CMPQ_COMPUTER_SYSTEM”, and the ontology properties of class “ComputerSystem” to which they correspond. For example, the field “TEMPER_FAHREN” is mapped to the property “operatingTemperatureFahrenheit”.

Preferably, through screens 1001 and 1002, the user can modify mappings, for example, by adding new mappings and deleting existing mappings.

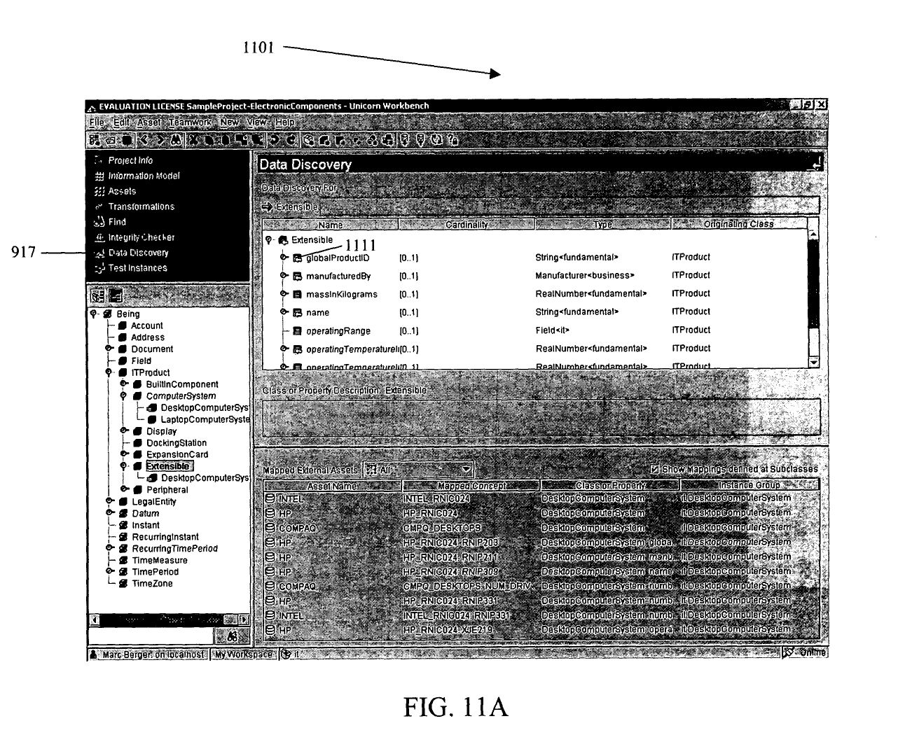

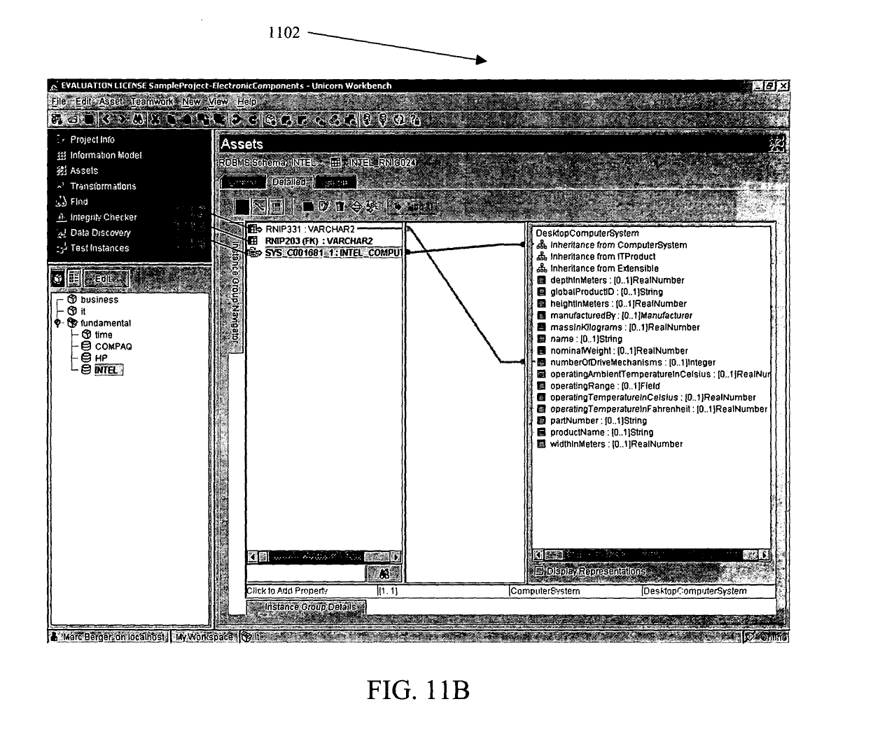

Reference is now made to FIG. 11A, which is an illustration of a user interface for discovering associations between asset metadata, in accordance with a preferred embodiment of the present invention. Shown in FIG. 11 is a screen 1101 displaying assets and concepts thereof, which are mapped to properties of a class named “Extensible”. For example, screen 1101 shows that a relational database schema named “INTEL” includes a table named “INTEL_RNIC024” which is associated with class “Extensible”. Icons 1111, with left arrows, designate properties from the information model which have asset metadata constructs mapped thereto. To see details of the relationship, a user can right-click on the table “INTEL_RNIC024”, in response to which screen 1102 of FIG. 11B is displayed.

Reference is now made to FIG. 11B, which shows details of an association discovered in FIG. 11A, in accordance with a preferred embodiment of the present invention. FIG. 11B includes a screen 1102, which shows that a field “RNIP331” of table INTEL_RNIC024 is mapped to a property “numberOfDriveMechanisms” inherited from class “Extensible”. Icon 1112, with a right arrow, designates a field, or table column, which is mapped into the information model. Icon 1113, without a right arrow, designates a field which is not mapped into the information model. Icon 1114, with a right arrow, designates a foreign key which is mapped into the information model. A foreign key is a field of one table that serves as a key for another table.

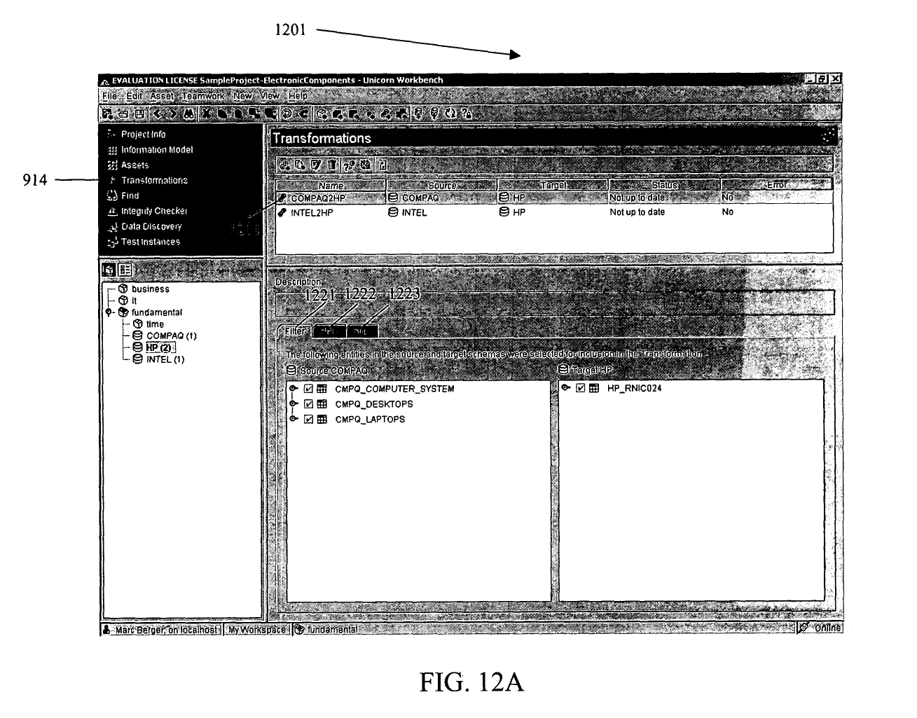

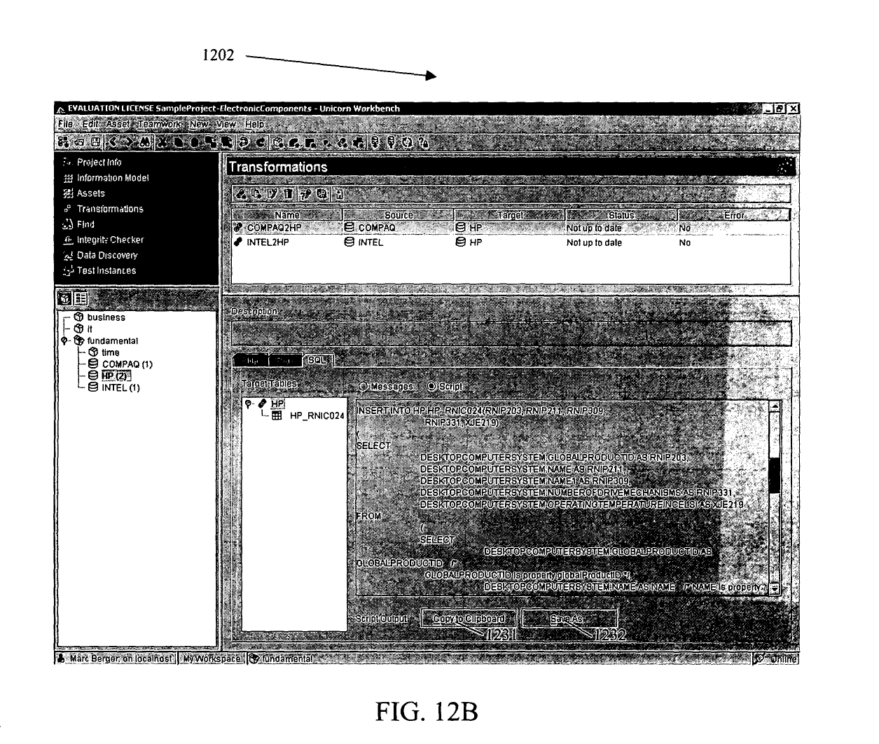

Reference is now made to FIGS. 12A and 12B, which are illustrations of a user interface for generating transformations, in accordance with a preferred embodiment of the present invention. Shown in FIG. 12A is a screen 1201, which is displayed in response to a user clicking on “Transformations” icon 114. Screen 1201 shows a transformation named “COMPAQ2HP”, designated by an icon 1211, for transforming three source relational database tables, “CMPQ_COMPUTER_SYSTEM”, “CMPQ_DESKTOPS” and “CMPQ_LAPTOPS”, from a relational database schema named “COMPAQ”, to a single target relational database table “HP_RNIC024” from a relational database schema named “HP”. Such a transformation, for example, can be used to transform hardware inventory data from a schema used by Compaq Computers, to a schema used by Hewlett-Packard Co. Screen 1201 includes three tabs, as follows:

a “Filter” tab 1221, shown selected in FIG. 12A, for specifying the action of a desired transformation;

a “Plan” tab 1222, for displaying a transformation planner spreadsheet, similar to the spreadsheet illustrated in FIG. 2J; and

an “SQL” tab 1223, for displaying derived SQL script for a desired transformation.

To view derived SQL script for transformation “COMPAQ2HP”, a user clicks on SQL tab 1223, in response to which screen 1202 of FIG. 12B is displayed. The user can copy the SQL script to a clipboard, or save it as a file, by clicking on respective buttons 1231 “Copy to Clipboard”, or 1232 “Save As . . . ”.

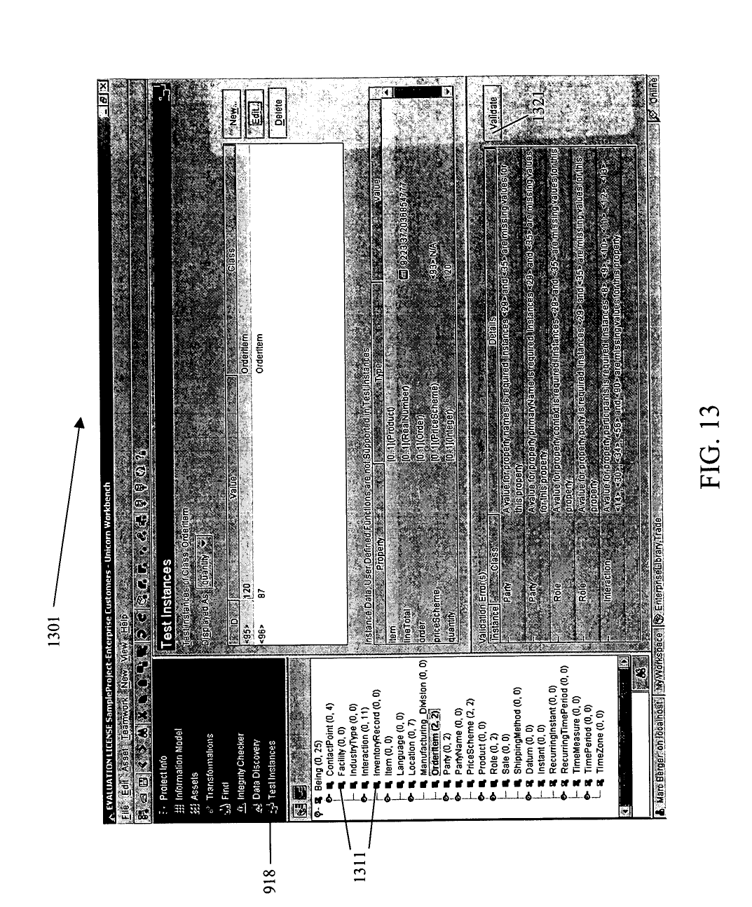

Reference is now made to FIG. 13, which is an illustration of a user interface for test instances, in accordance with a preferred embodiment of the present invention. Shown in FIG. 13 is a screen 1301 displaying a hierarchical list of ontology classes on the left, and instances thereof, designated by icons 1311, on the right. For example, shown in screen 1301 is a test instance for class “OrderItem”, with ID=95, and a value of 120 for property “quantity”. In a preferred embodiment of the present invention, a user can click on a “Validate” button 1321, to determine whether or not the test instance data is well-defined and complaint with the data types and business rules of the project.

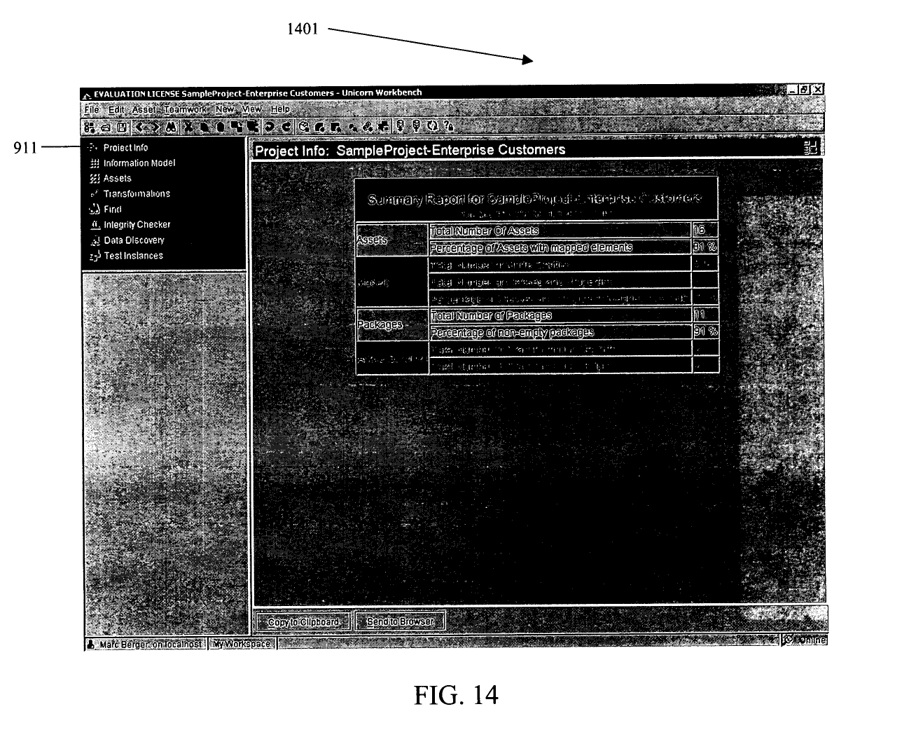

Reference is now made to FIG. 14, which is an illustration of a user interface for obtaining general information about an enterprise information project, in accordance with a preferred embodiment of the present invention. Shown in FIG. 14 is a screen 1401, which is displayed in response to a user clicking on “Project Info” button 911. Screen 1401 displays statistics about a project, similar to the statistics embodied in the statistical graph displayed in FIG. 7.

Implementation Details

In a preferred embodiment of the present invention, an overall project, including inter alia asset metadata, an information model, mappings and business rules and their inter-relationships, are represented as a directed graph. The nodes of the graph correspond to schema, composites, atoms and business rules. Each composite of a schema is connected to the schema by a directed edge going from the composite to the schema. Similarly, each atom of a composite is connected to the composite by a directed edge going from the atom to the composite. Classes and properties of the information model also conform to this convention, and thus a directed edge from a property to a class indicates that the property belongs to the class, and a directed edge from a class to the information model indicates that the class belongs to the information model.

A mapping between a composite of a schema and a corresponding class of the information model is designated by a pair of directed edges in both directions, between the composite and the class. Similarly, a mapping between an atom of a schema and a corresponding property of the information model is designated by a pair of directed edges in both directions, between the atom and the property.

In addition, edges between classes of the information model denote inheritance; i.e., the class at the tail of the edge is a subclass of the class at the head of the edge. For a node that represents a business rule, the nodes for the properties to which the business rule relate have directed edges leading into the business rule. The rule itself is stored within the business rule node.

Preferably, a directed edge from a first schema to a second schema indicates that an enterprise application alters the second schema using input from the first schema, thus generating a dependency between the schemas.

In a preferred embodiment of the present invention, a web client accesses the directed graph by means of a “Path-Finder” tool. The Path-Finder is a programming interface to the graph, which receives a query as input and returns one or more paths within the graph as output. Examples of queries include inter alia:

Q1: Find all paths originating from a prescribed node.

Query Q1 corresponds to analyzing the impact of modifying the project construct corresponding to the prescribed node.

Q2: Find all paths originating from a prescribed composite node, and terminating at other schema composite nodes.

Query Q2 corresponds to finding all asset metadata composites that correspond to one another; namely, that are mapped to the same ontology class in the information model as is the prescribed composite.

Q3: Find all paths terminating at one or more prescribed atomic nodes, and originating at an atomic node.

Query Q3 corresponds to finding transformations to generate one or more prescribed atomic nodes.

The active capabilities of transformation planning, impact analysis and business rule validation described hereinabove with reference to FIGS. 2I-2K, 3A-3E and 4A-4D, are preferably carried out through the intermediary of the Path-Finder.

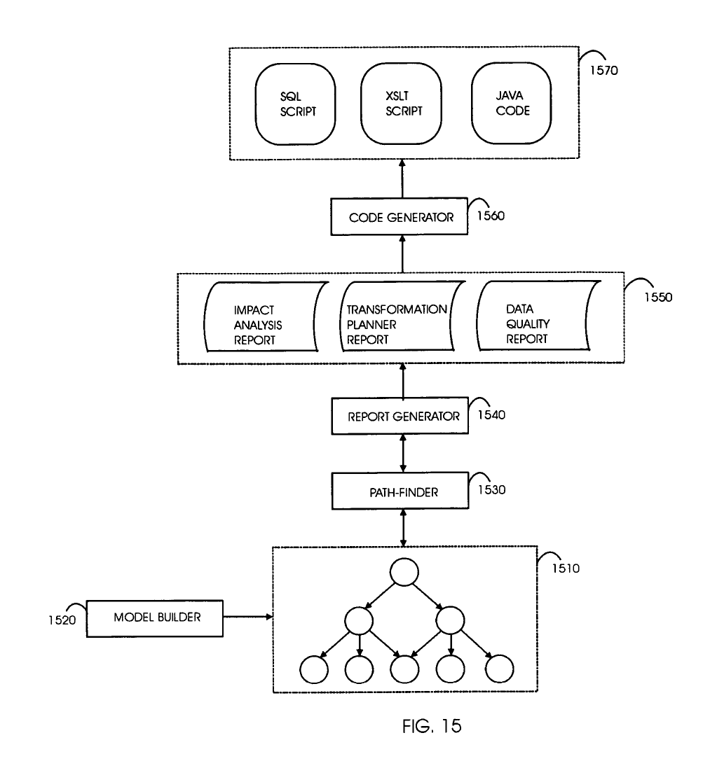

Reference is now made to FIG. 15, which is a simplified block diagram for a web portal server that enables an interactive web client, in accordance with a preferred embodiment of the present invention. Shown in FIG. 15 is a data structure 1510 in the form of a graph, representing enterprise asset metadata and a global information model. Data structure 1510 is generated by a model builder 1520 that enables importing data assets, building the information model, mapping assets to the information model, and formulating business rules.

Data structure 1510 is accessed through a path-finder tool 1530, which is a layer that interfaces with data structure 1510 and with higher level applications. Path-finder tool 1530 displays paths within the data structure graph that satisfy prescribed query criteria, such as the criteria of queries Q1-Q3 hereinabove. Report generator 1540 is a higher level application that generates reports about data structure 1510, including inter alia impact analysis reports (FIG. 3D), transformation planner reports (FIG. 2J) and data quality reports (FIG. 4D), designated by numeral 1550.

Reports 1550 include methodology-type reports, which describe steps necessary to accomplish an objective, such as to perform a data transformation or to verify compliance with a business rule. For such reports, a code generator 1560 is used to produce formal program code, including inter alia SQL script, XSLT script and Java code, designated by numeral 1570, which can be used to perform the necessary steps described in the report. The SQL script shown in FIG. 2K is an example of code generated by code generator 1560.

It may be appreciated by those skilled in the art that the present invention may be embodied as a system using a web portal, as described hereinabove, or within a non-portal viewer tool.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A system for interactively viewing enterprise metadata, comprising:
a memory for storing a data structure in the form of a graph, with nodes representing asset metadata for enterprise data assets and edges representing relationships between asset metadata;
a path finder for generating at least one path within the graph satisfying prescribed constraints; and
a report generator for generating a report about the graph, based on paths generated by said path finder.

2. The system of claim 1 further comprising a web portal user interface, through which said report generator is activated.

3. The system of claim 1 further comprising a viewer tool user interface, through which said report generator is activated.

4. The system of claim 1 wherein the report is an impact analysis report, describing the impact on the asset metadata, of at least one prescribed modification to a portion of the asset metadata.

5. The system of claim 1 wherein the report is an impact analysis report, describing the impact on the enterprise data assets, of at least one prescribed modification to a portion of the asset metadata.

6. The system of claim 1 wherein the report is a transformation planning report, describing steps to transform data from one asset to another.

7. The system of claim 1 wherein the report is a data quality report, describing steps to verify compliance of asset data with at least one prescribed business rule.

8. The system of claim 1 wherein the report is a data discovery report, displaying asset metadata within the enterprise data assets that correspond with a prescribed asset metadata.

9. The system of claim 8 wherein the report is a data discovery report, displaying asset metadata within the enterprise data assets that are equivalent to a prescribed asset metadata, in the sense that the corresponding data is represented the same way.

10. The system of claim 8 wherein the report is a data discovery report, displaying asset metadata within the enterprise data assets that are equivalent to a prescribed asset metadata, in the sense that the corresponding data is represented in an equivalent way.

11. The system of claim 8 wherein the report is a data discovery report, displaying asset metadata within the enterprise data assets that are logically dependent on a prescribed asset metadata.

12. The system of claim 8 wherein the report is a data discovery report, displaying asset metadata within the enterprise data assets upon which a prescribed asset metadata is logically dependent.

13. The system of claim 8 wherein the report is a data discovery report, displaying asset metadata within the enterprise data assets that correspond with a prescribed asset metadata, and have a more specific context.

14. The system of claim 8 wherein the report is a data discovery report, displaying asset metadata within the enterprise data assets that correspond with a prescribed asset metadata, and have a more general context.

15. The system of claim 8 wherein the report is a data discovery report, displaying asset metadata within the enterprise data assets that comprise data corresponding with a prescribed asset metadata.

16. The system of claim 8 wherein the report is a data discovery report, displaying asset metadata within the enterprise data assets that correspond to data comprised within a prescribed asset metadata.

17. The system of claim 1 wherein the report is a statistical summary report describing statistics about the asset metadata.

18. The system of claim 17 wherein the statistical summary report describes a distribution of enterprise data assets based on at least one descriptor.

19. The system of claim 18 wherein the statistical summary report describes a distribution of enterprise data assets based on owner.

20. The system of claim 18 wherein the statistical summary report describes a distribution of a enterprise data assets based on a quality level.

21. The system of claim 1 further comprising a data redundancy analyzer for identifying redundancies among the enterprise data assets.

22. The system of claim 21 wherein the report is a plan for eliminating redundancies among the enterprise data assets.

23. The system of claim 1 wherein the report is a comparison report, comparing metadata for at least one enterprise data asset with metadata for a specific enterprise data asset designated as a base for comparison.

24. The system of claim 23 wherein the comparison report indicates metadata for the at least one enterprise data asset that corresponds with metadata for the specific enterprise data asset, and has a more general context.

25. The system of claim 23 wherein the comparison report indicates metadata for the at least one enterprise data asset that corresponds with metadata for the specific enterprise data asset, and has a more specific context.

26. The system of claim 1 further comprising a code generator, for generating program code instructions corresponding to a report.

27. The system of claim 26 wherein the program code instructions are expressed as SQL script.

28. The system of claim 26 wherein the program code instructions are expressed as XSLT script.

29. The system of claim 26 wherein the program code instructions are expressed as Java code.

30. The system of claim 26 wherein the program code instructions are expressed as a transformation planning report, describing steps to transform data from one asset to another.

31. The system of claim 1 further comprising a request-for-change generator, for generating a request to apply at least one modification to the graph.

32. The system of claim 31 wherein said request-for-change generator enforces at least one approval process for the request.

33. The system of claim 1 wherein the graph includes nodes for an ontology model, into which asset metadata is mapped.

34. The system of claim 33 wherein the ontology model is a generic industry model.

35. The system of claim 33 wherein the ontology model is an enterprise specific model.

36. The system of claim 33 wherein edges connect pairs of nodes that correspond to metadata that is mapped to one another.

37. The system of claim 33 wherein the report is a statistical summary report describing a percentage of enterprise data assets for which asset metadata is mapped to the ontology model.

38. The system of claim 33 wherein the report is a statistical summary report describing a percentage of enterprise data assets for which asset metadata is completely mapped to the ontology model.

39. The system of claim 33 wherein the report is a statistical summary report describing a percentage of enterprise data assets for which asset metadata is partially mapped to the ontology model.

40. The system of claim 33 wherein the report is a comparison report, comparing metadata for at least one enterprise data asset with metadata for the ontology model.

41. The system of claim 40 wherein the comparison report indicates metadata for the at least one enterprise data asset that corresponds with metadata for the ontology model, and has a more general context.

42. The system of claim 40 wherein the comparison report indicates metadata for the at least one enterprise data asset that corresponds with metadata for the ontology model, and has a more specific context.

43. The system of claim 1 further comprising an access controller for restricting a user's access to asset metadata based on a user privilege.

44. The system of claim 1 further comprising an access controller for restricting a user's access to asset metadata based on a requested action.

45. The system of claim 1 further comprising an access controller for restricting a user's access to asset metadata based on a subject area of asset metadata.

46. The system of claim 1 further comprising a filter for displaying different parts of the asset metadata to different types of users.

47. The system of claim 1 further comprising a filter for displaying different parts of the asset metadata to technical and non-technical users.

48. The system of claim 1 further comprising a filter for displaying asset metadata in different formats to different types of users.

49. A method for interactively viewing enterprise metadata, comprising:
providing a data structure in the form of a graph, with nodes representing asset metadata for enterprise data assets and edges representing relationships between asset metadata;
generating at least one path within the graph satisfying prescribed constraints; and
generating a report about the graph, based on paths generated by said path finder.

50. The method of claim 49 wherein the report is an impact analysis report, describing the impact on the asset metadata, of at least one prescribed modification to a portion of the asset metadata.

51. The method of claim 49 wherein the report is an impact analysis report, describing the impact on the enterprise data assets, of at least one prescribed modification to a portion of the asset metadata.

52. The method of claim 49 wherein the report is a transformation planning report, describing steps to transform data from one asset to another.

53. The method of claim 49 wherein the report is a data quality report, describing steps to verify compliance of asset data with at least one prescribed business rule.

54. The method of claim 49 wherein the report is a data discovery report, displaying asset metadata within the enterprise data assets that correspond with a prescribed asset metadata.

54. The method of claim 53 wherein the report is a data discovery report, displaying asset metadata within the enterprise data assets that are equivalent to a prescribed asset metadata, in the sense that the corresponding data is represented the same way.

56. The method of claim 54 wherein the report is a data discovery report, displaying asset metadata within the enterprise data assets that are equivalent to a prescribed asset metadata, in the sense that the corresponding data is represented in an equivalent way.

57. The method of claim 54 wherein the report is a data discovery report, displaying asset metadata within the enterprise data assets that are logically dependent on a prescribed asset metadata.

58. The method of claim 54 wherein the report is a data discovery report, displaying asset metadata within the enterprise data assets upon which a prescribed asset metadata is logically dependent.

59. The method of claim 54 wherein the report is a data discovery report, displaying asset metadata within the enterprise data assets that correspond with a prescribed asset metadata, and have a more specific context.

60. The method of claim 54 wherein the report is a data discovery report, displaying asset metadata within the enterprise data assets that correspond with a prescribed asset metadata, and have a more general context.

61. The method of claim 54 wherein the report is a data discovery report, displaying asset metadata within the enterprise data assets that comprise data corresponding with a prescribed asset metadata.

62. The method of claim 54 wherein the report is a data discovery report, displaying asset metadata within the enterprise data assets that correspond to data comprised within a prescribed asset metadata.

63. The method of claim 49 wherein the report is a statistical summary report describing statistics about the asset metadata.

64. The method of claim 63 wherein the statistical summary report includes a distribution of enterprise data assets based on at least one descriptor.

65. The method of claim 64 wherein the statistical summary report includes a distribution of enterprise data assets based on owner.

66. The method of claim 64 wherein the statistical summary report includes a distribution of a enterprise data assets based on a quality level.

67. The method of claim 49 further comprising identifying redundancies among the enterprise data assets.

68. The method of claim 67 wherein the report is a plan for eliminating redundancies among the enterprise data assets.

69. The method of claim 49 wherein the report is a comparison report, comparing metadata for at least one enterprise data asset with metadata for a specific enterprise data asset designated as a base for comparison.

70. The method of claim 69 wherein the comparison report indicates metadata for the at least one enterprise data asset that corresponds with metadata for the specific enterprise data asset, and has a more general context.

71. The method of claim 69 wherein the comparison report indicates metadata for the at least one enterprise data asset that corresponds with metadata for the specific enterprise data asset, and has a more specific context.

72. The method of claim 49 further comprising generating program code instructions corresponding to a report.

73. The method of claim 72 wherein the program code instructions are expressed as SQL script.

74. The method of claim 72 wherein the program code instructions are expressed as XSLT script.

75. The method of claim 72 wherein the program code instructions are expressed as Java code.

76. The method of claim 72 wherein the program code instructions are expressed as a transformation planning report, describing steps to transform data from one asset to another.

77. The method of claim 49 further comprising generating a request to apply at least one modification to the graph.

78. The method of claim 77 further comprising enforcing at least one approval process for the request.

79. The method of claim 49 wherein the graph includes nodes for an ontology model, into which asset metadata is mapped.

80. The method of claim 79 wherein the ontology model is a generic industry model.

81. The method of claim 79 wherein the ontology model is an enterprise specific model.

82. The method of claim 79 wherein edges connect pairs of nodes that correspond to metadata that is mapped to one another.

83. The method of claim 79 wherein the report is a statistical summary report describing a percentage of enterprise data assets for which asset metadata is mapped to the ontology model.

84. The method of claim 79 wherein the report is a statistical summary report describing a percentage of enterprise data assets for which asset metadata is completely mapped to the ontology model.

85. The method of claim 79 wherein the report is a statistical summary report describing a percentage of enterprise data assets for which asset metadata is partially mapped to the ontology model.

86. The method of claim 79 wherein the report is a comparison report, comparing metadata for at least one enterprise data asset with metadata for the ontology model.

87. The method of claim 86 wherein the comparison report indicates metadata for the at least one enterprise data asset that corresponds with metadata for the ontology model, and has a more general context.

88. The method of claim 86 wherein the comparison report indicates metadata for the at least one enterprise data asset that corresponds with metadata for the ontology model, and has a more specific context.

89. The method of claim 49 further comprising restricting a user's access to asset metadata based on a user privilege.

90. The method of claim 49 further comprising restricting a user's access to asset metadata based on a requested action.

91. The method of claim 49 further comprising restricting a user's access to asset metadata based on a subject area of asset metadata.

92. The method of claim 49 further comprising displaying different parts of the asset metadata to different types of users.

93. The method of claim 49 further comprising displaying different parts of the asset metadata to technical and non-technical users.

94. The method of claim 49 further comprising displaying asset metadata in different formats to different types of users.

95. A computer-readable storage medium storing program code for causing a computer to perform the steps of:
providing a data structure in the form of a graph, with nodes representing asset metadata for enterprise data assets and edges representing relationships between asset metadata;
generating at least one path within the graph satisfying prescribed constraints; and
generating a report about the graph, based on paths generated by said path finder.
